(19) United States
(12) Patent Application Publication
(10) Pub. No.: US 2020/0372472 A1
(43) Pub. Date: Nov. 26, 2020

(54) MULTI-LEVEL RANKING FOR MITIGATING MACHINE LEARNING MODEL BIAS

(71) Applicant: Microsoft Technology Licensing, LLC, Redmond, WA (US)

(72) Inventors: Krishnaram Kenthapadi, Sunnyvale, CA (US); Sahin C. Geyik, Redwood City, CA (US); Stuart M. Ambler, Redwood City, CA (US)

(73) Assignee: Microsoft Technology Licensing, LLC, Redmond, WA (US)

(21) Appl. No.: 16/050,764

(22) Filed: Jul. 31, 2018

(51) Int. Cl. G06Q 10/10; G06F 15/18; G06F 17/18; G06F 17/30

(52) U.S. Cl. CPC G06Q 10/1053; G06F 17/30964; G06F 17/18; G06F 15/18

(57) ABSTRACT

The disclosed embodiments provide a system for performing multi-level ranking for mitigating machine learning model bias. During operation, the system applies a machine learning model to features for qualified candidates that match parameters of a request to produce a first ranking of recommended candidates. Next, the system calculates a distribution of an attribute in the qualified candidates and generates a first reranking of recommended candidates that more accurately reflects the distribution of the attribute in the qualified candidates. The system then applies another machine learning model to the first reranking to produce a second ranking of recommended candidates and generates a second reranking of recommended candidates that more accurately reflects the distribution of the attribute in the qualified candidates. Finally, the system outputs at least a portion of the second reranking in a response to the request.

### RELATED APPLICATIONS

The subject matter of this application is related to the subject matter in a co-pending non-provisional application by the same inventors as the instant application and filed on the same day as the instant application, entitled “Quantifying Bias in Machine Learning Models,” having serial number TO BE ASSIGNED, and filing date TO BE ASSIGNED (Attorney Docket No. LI-902300-US-NP).

The subject matter of this application is also related to the subject matter in a co-pending non-provisional application by the same inventors as the instant application and filed on the same day as the instant application, entitled “Reranking Results to Achieve Fairness in Underrepresented Groups,” having serial number TO BE ASSIGNED, and filing date TO BE ASSIGNED (Attorney Docket No. LI-902301-US-NP).

The subject matter of this application is also related to the subject matter in a co-pending non-provisional application by the same inventors as the instant application and filed on the same day as the instant application, entitled “Achieving Fairness Across Multiple Attributes in Rankings,” having serial number TO BE ASSIGNED, and filing date TO BE ASSIGNED (Attorney Docket No. LI-902302-US-NP).

The subject matter of this application is also related to the subject matter in a co-pending non-provisional application by the same inventors as the instant application and filed on the same day as the instant application, entitled “Interval Constrained Sorting for Feasible Bias Mitigation,” having serial number TO BE ASSIGNED, and filing date TO BE ASSIGNED (Attorney Docket No. LI-902303-US-NP).

### BACKGROUND

### Field

The disclosed embodiments relate to data analysis and machine learning. More specifically, the disclosed embodiments relate to techniques for performing multi-level ranking for mitigating machine learning model bias.

### Related Art

Analytics may be used to discover trends, patterns, relationships, and/or other attributes related to large sets of complex, interconnected, and/or multidimensional data. In turn, the discovered information may be used to gain insights and/or guide decisions and/or actions related to the data. For example, business analytics may be used to assess past performance, guide business planning, and/or identify actions that may improve future performance.

To glean such insights, large data sets of features may be analyzed using regression models, artificial neural networks, support vector machines, decision trees, naïve Bayes classifiers, and/or other types of machine learning models. The discovered information may then be used to guide decisions and/or perform actions related to the data. For example, the output of a machine learning model may be used to generate marketing or advertising decisions, assess risk, make relevant or useful recommendations, detect fraud, predict behavior, and/or customize or optimize use of an application or website.

On the other hand, machine learning models can exhibit bias that influences predictions, estimates, classifications, scores, recommendations, and/or other inferences or properties outputted by the machine learning models. Such biases may reflect human and/or societal biases that are present during the creation, selection, and/or use of data sets used to train the machine learning models. In turn, biased machine learning models may generate output that results in systematic discrimination and reduced visibility for already disadvantaged groups such as minorities and/or certain races or genders.

Consequently, data analytics and machine learning may be improved by developing techniques to detect and reduce bias in machine learning models.

### BRIEF DESCRIPTION OF THE FIGURES

FIG. 1 shows a schematic of a system in accordance with the disclosed embodiments.

FIG. 2 shows a multi-level ranking architecture for mitigating bias in machine learning models in accordance with the disclosed embodiments.

FIG. 3 shows a flowchart illustrating a process of quantifying bias in a machine learning model in accordance with the disclosed embodiments.

FIG. 4 shows a flowchart illustrating a process of reranking to achieve fairness in an underrepresented group in accordance with the disclosed embodiments.

FIG. 5 shows a flowchart illustrating a process of generating a reranking of recommended candidates that includes a target proportion of an attribute in accordance with the disclosed embodiments.

FIG. 6 shows a flowchart illustrating a process of achieving fairness across multiple attributes in rankings in accordance with the disclosed embodiments.

FIG. 7 shows a flowchart illustrating a process of generating a reranking of recommended candidates based on target proportions of multiple attribute values in accordance with the disclosed embodiments.

FIG. 8 shows a flowchart illustrating a process of generating a reranking of recommended candidates based on target proportions of multiple attribute values in accordance with the disclosed embodiments.

FIG. 9 shows a flowchart illustrating a process of performing interval constrained sorting for feasible bias mitigation in accordance with the disclosed embodiments.

FIG. 10 shows a flowchart illustrating a process of performing multi-level reranking to mitigate machine learning model bias in accordance with the disclosed embodiments.

FIG. 11 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The disclosed embodiments provide a method, apparatus, and system for detecting and/or managing bias in machine learning models. Such bias may reflect inherent human and/or societal biases that are present during the creation, selection, and/or use of data sets used to train the machine learning models. Bias may further be present in the subsequent interpretation and/or use of rankings or other output from the machine learning models.

More specifically, the disclosed embodiments include functionality to rerank the output of machine learning models to increase fairness in underrepresented groups. Such reranking may be performed using one distribution of an attribute in a set of qualified candidates that match parameters of a request and another distribution of the attribute in a ranking of recommended candidates generated by a machine learning model after the qualified candidates are inputted into the machine learning model. For example, the request may include parameters representing characteristics of the candidates that are desired or required for an opportunity (e.g., job, position, scholarship, fellowship, award, etc.). As a result, qualified candidates may include users with characteristics that match the parameters, and the ranking may include an ordering of the qualified candidates by scores outputted by the machine learning model, which reflect the model's assessment of the relative strengths of the qualified candidates for the opportunity.

A system for generating rerankings of candidates may include multiple rankers that perform multiple levels and/or rounds of ranking and reranking of qualified candidates that match parameters of a request. A first ranker may perform a fan-out of the request to a number of partitions, and each partition may respond to the request with a different subset of qualified candidates that match parameters of the request. Each partition may also calculate a distribution of an attribute in the corresponding subset of qualified candidates. The first ranker may then apply a first machine learning model to features for the qualified candidates to generate scores for the qualified candidates. The first ranker also produces a ranking of candidates by ordering the qualified candidates by descending score from the machine learning model.

The first ranker further uses the distribution of qualified candidates to perform a reranking that reduces bias from the machine learning model in generating the original ranking. For example, the ranker may aggregate values of the distribution from the partitions into an overall distribution of qualified candidates for the request. The ranker may use the overall distribution, a tolerance factor, and/or one or more user-specified parameters to determine target proportions of one or more attribute values in the ranking. The ranker may also use one or more reranking techniques to generate the reranking so that the reranking better conforms to the target proportions of the attributes.

The system may then use a second ranker to generate a second ranking of the candidates. For example, the second ranker may use a second machine learning model to generate a new set of scores for some or all candidates in the reranking outputted by the first ranker. Features inputted into the second machine learning model may differ from and/or overlap with features inputted into the first machine learning model. As a result, scores and/or rankings outputted by the second machine learning model and/or ranker may differ from those outputted by the first machine learning model and/or ranker.

The second ranker may also use target proportions of attributes from the first ranker to generate a second reranking of the candidates from the second ranking. As with the first ranker, the second ranker may use various reranking techniques to reduce bias in scores from the second machine learning model and/or meet target proportions associated with the distribution of the attribute.

Finally, at least a portion of the second reranking is outputted in a response to the request. For example, a certain portion of the original ranking or rankings (e.g., the top “n” candidates) may be replaced with the second reranking to improve the representation of one or more attribute values in top-ranked candidates shown to a user making the request.

By performing multiple levels of ranking and reranking of qualified candidates that match parameters of a request, the disclosed embodiments may improve the quality and fairness of results returned in response to the request. For example, the first ranker may generate a coarse-grained ranking and/or reranking from all qualified candidates returned by the partitions, while the second ranker may incur higher computational overhead to generate a more accurate or relevant ranking and/or reranking from a smaller set of qualified candidates. The number of candidates scored, ranked, and/or reranked by each ranker and/or machine learning model may be selected to accommodate performance and/or scalability constraints associated with generating results in response to requests received by the system. Consequently, the disclosed embodiments may improve technologies related to online networks, machine learning models, recommendations, and/or rankings; performance and use of network-enabled devices and/or applications that access or execute the online networks, machine learning models, recommendations, and/or rankings; and/or user engagement, experience, and interaction involving the online networks, machine learning models, recommendations, and/or rankings.

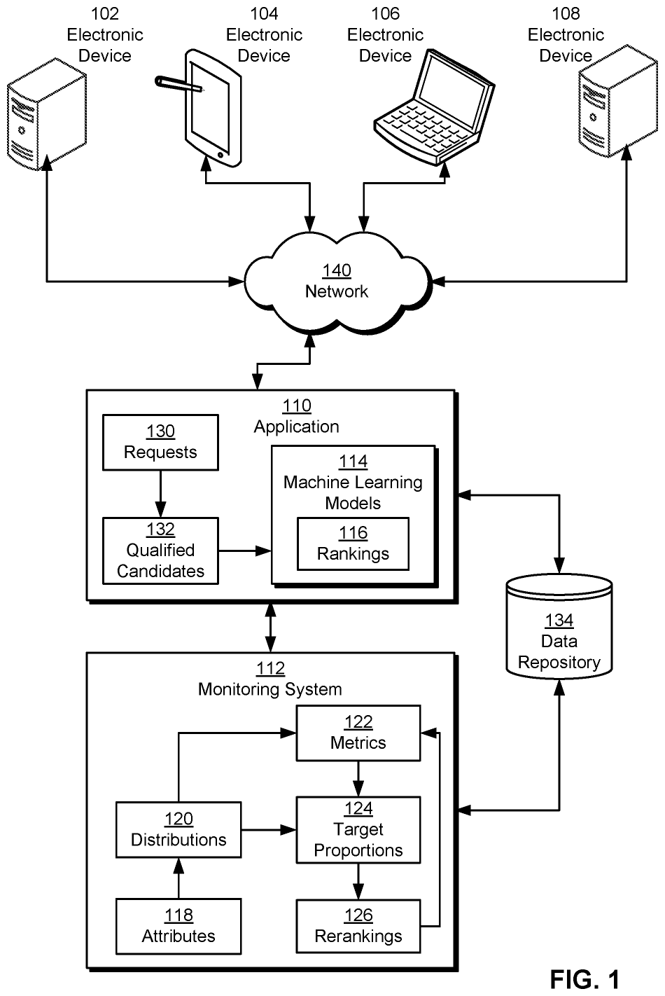

FIG. 1 shows a schematic of a system in accordance with the disclosed embodiments. As shown in FIG. 1, a monitoring system 112 may monitor the execution and/or output of a set of machine learning models 114 such as regression models, artificial neural networks, support vector machines, decision trees, naïve Bayes classifiers, Bayesian networks, random forests, gradient boosted trees, hierarchical models, and/or ensemble models.

Machine learning models 114 may be used with and/or execute within an application 110 that is accessed by a set of electronic devices 102-108 over a network 140. For example, application 110 may be a native application, web application, one or more components of a mobile application, and/or another type of client-server application that is accessed over a network 140. Electronic devices 102-108 may be personal computers (PCs), laptop computers, tablet computers, mobile phones, portable media players, workstations, gaming consoles, and/or other network-enabled computing devices that are capable of executing application 110 in one or more forms. To exchange data with application 110, electronic devices 102-108 may connect to application 110 over a local area network (LAN), wide area network (WAN), personal area network (PAN), virtual private network, intranet, mobile phone network (e.g., a cellular network), WiFi network, Bluetooth network, universal serial bus (USB) network, Ethernet network, and/or another type of network.

During use of application 110, users of electronic devices 102-108 may generate and/or provide data that is used as input to machine learning models 114. Machine learning models 114 may analyze the data to discover relationships, patterns, and/or trends in the data; gain insights from the input data; and/or guide decisions or actions related to the data.

For example, the users may use application 110 to access an online professional network, social network, and/or other type of online network or community. During use of application 110, the users may perform tasks such as establishing and maintaining professional connections; receiving and interacting with updates in the users' networks, professions, or industries; listing educational, work, and community experience; endorsing and/or recommending one another; listing, searching, and/or applying for jobs; searching for or contacting job candidates; providing business- or company-related updates; and/or conducting sales, marketing, e-learning, and/or advertising activities.

As a result, data that is inputted into machine learning models 114 may include, but is not limited to, profile updates, profile views, connections, endorsements, invitations, follows, posts, comments, likes, shares, searches, clicks, conversions, messages, interactions with groups, job applications, job views, job searches, interaction between job seekers and recruiters, address book interactions, responses to recommendations, purchases, and/or other implicit or explicit feedback from the users. In turn, machine learning models 114 may generate output that includes scores (e.g., connection strength scores, reputation scores, seniority scores, relevance scores, etc.), classifications (e.g., classifying users as job seekers or employed in certain roles), recommendations (e.g., content recommendations, job recommendations, skill recommendations, connection recommendations, etc.), estimates (e.g., estimates of spending), predictions (e.g., predictive scores, propensity to buy, propensity to churn, propensity to unsubscribe, etc.), and/or other inferences or properties.

In one or more embodiments, data received from electronic devices 102-108 is aggregated into a data repository 134 for subsequent retrieval and use. For example, each profile update, profile view, connection, follow, post, comment, like, share, search, click, message, interaction with a group, address book interaction, response to a recommendation, purchase, and/or other action performed by a user or other entity with application 110 and/or the online network may be tracked and stored in a database, data warehouse, cloud storage, and/or other data-storage mechanism providing data repository 134.

In turn, machine learning models 114 may use data in data repository 134 to generate recommendations and/or other insights related to jobs or other types of opportunities in the online network. For example, one or more components of application 110 and/or the online network may track searches, clicks, views, text input, conversions, and/or other feedback during the entities' interaction with a job search and/or recruiter tool in the online professional network. The feedback may be stored in data repository 134 and used as training data for one or more machine learning models 114, and rankings 116 and/or other output of machine learning models 114 may be used to display and/or recommend a number of job listings to job seekers.

Data in data repository 134 may also, or instead, be used with one or more machine learning models 114 to produce rankings 116 of recommended candidates for opportunities (e.g., jobs, scholarships, school admissions, loans, leases, fellowships, artistic positions, musical positions, contracts, awards, etc.) listed within or outside the online network. The candidates may include users who have viewed, searched for, or applied to the opportunities, within or outside the online network. The candidates may alternatively or additionally include users and/or members of the online network with skills, work experience, education, industries, demographic attributes, and/or other attributes or qualifications that match the corresponding opportunities.

Rankings 116 may be generated in response to requests 130 from application 110 and/or users of application 110. For example, requests 130 may be received from recruiters, hiring managers, human resources employees, and/or other users of application 110. The users may interact with checkboxes, radio buttons, drop-down menus, text boxes, and/or other user-interface elements provided by application 110 to specify parameters related to candidates for an opportunity. The parameters may include, but are not limited to, a location, industry, title, skill, school, degree, company, work experience, seniority, keywords, awards, publications, patents, licenses and certifications, and/or other characteristics of the candidates that are desired or required for the opportunity.

To process a given request, one or more components of application 110 may transmit a query containing parameters of the request to data repository 134. In response to the query, data repository 134 may return member identifiers and/or profile data for a set of qualified candidates 132 that match the parameters.

After qualified candidates 132 are identified, profile and/or activity data of qualified candidates 132 may be inputted into machine learning models 114, along with features and/or characteristics of the corresponding opportunity (e.g., required or desired skills, education, previous positions, current position, years of experience, industry, title, location, etc.). Machine learning models 114 may then output scores representing the strengths of qualified candidates 132 with respect to the opportunity and/or qualifications related to the opportunity. For example, machine learning models 114 may generate scores based on similarities between the candidates' profile data and descriptions of the opportunities. Machine learning models 114 may further adjust the scores based on social and/or other validation of the candidates' profile data (e.g., endorsements of skills, recommendations, accomplishments, awards, publications, reputation scores, etc.). One or more rankings 116 of recommended candidates may then be generated by ordering qualified candidates 132 by descending score.

Rankings 116 and/or associated insights may improve the quality of the candidates and/or recommendations of opportunities to the candidates, increase user activity with the online network, and/or guide the decisions of the candidates and/or moderators involved in screening for or placing the opportunities (e.g., hiring managers, recruiters, human resources professionals, admissions officers, selection committees, etc.). For example, one or more components of application 110 may display and/or otherwise output a member's position (e.g., top 10%, top 20 out of 138, etc.) in a ranking of candidates for a job to encourage the member to apply for jobs in which the member is highly ranked. In a second example, the component(s) may account for a candidate's relative position in rankings 116 for a set of jobs during ordering of the jobs as search results in response to a job search by the candidate. In a third example, a ranking of candidates for a given set of job qualifications may be displayed as search results to a recruiter after the recruiter submits a search request (e.g., requests 130) with the job qualifications included as parameters of the search request.

On the other hand, machine learning models 114 may exhibit bias that affects rankings 116 and/or other output of machine learning models 114, as well as subsequent insights and/or decisions derived from the output. Such biases may reflect inherent human and/or societal biases that are present during the creation, selection, and/or use of data sets used to train machine learning models 114. Bias may further be present in the subsequent interpretation and/or use of rankings 116 and/or other output from machine learning models 114.

For example, machine learning models 114 may produce biased output when training data for machine learning models 114 includes or encodes gendered wording, labels obtained from human recruiters with inherent biases, and/or correlations between user behavior and demographic groups (e.g., genders, age ranges, ethnicities, locations, etc.). In another example, pagination of rankings 116 from machine learning models 114 may result in preferential selection of candidates from the first page of candidates in each ranking over subsequent pages of candidates in the ranking. Consequently, bias in machine learning models 114 may exacerbate systematic discrimination and reduced visibility for already disadvantaged groups such as minorities and/or certain races or genders.

In one or more embodiments, monitoring system 112 includes functionality to detect, quantify, and/or mitigate bias in machine learning models 114. A given machine learning model may be biased when the machine learning model systematically ranks members of a “disadvantaged” group with a certain attribute (e.g., gender, age range, ethnicity, location, etc.) below that of other groups, independently of whether the machine learning model uses the attribute explicitly as a feature or implicitly through redundant encoding of other features. Conversely, a machine learning model may be unbiased or “fair” when the proportion of the attribute in one or more sets of top-ranked results (e.g., the top 5, 10, 25, 50 candidates from rankings 116) generated in response to a request (e.g., requests 130) substantially matches the proportion of the attribute in qualified candidates 132 that match the same request.

In the context of generating rankings 116 of candidates from requests 130, an unordered set of qualified candidates 132 that matches the parameters of a request may be used as a baseline for detecting bias in machine learning models 114. The set of qualified candidates 132 may be used as input to one or more machine learning models 114 to generate a ranking (e.g., rankings 116) of candidates. The ranking may be based on scores that reflect the candidates' strength with respect to the corresponding opportunity (e.g., scores representing the likelihood that each candidate will be chosen for the opportunity and/or will receive a communication related to applying for the opportunity).

As a result, a candidate that is higher in the ranking may represent a stronger candidate than a candidate that is lower in the ranking. The candidate may also be more likely to be viewed and/or prioritized by the user making the request and/or application 110 than candidates that are lower in the ranking. Conversely, machine learning model bias may cause top-ranked candidates in the ranking to have a different distribution of one or more attributes 118 (e.g., gender, age, ethnicity, etc.) than the distribution found in all qualified candidates 132 that match the request. Such differences in distribution may further result in systematic discrimination and/or an unfair outcome for some qualified candidates 132 with certain attribute values. For example, a lower proportion of candidates with a certain gender, age range, ethnicity, and/or other attribute value in the first page of results shown in response to a recruiter's search may cause the recruiter to inadvertently favor candidates that lack the attribute value in screening for or placing the corresponding opportunity.

To detect and/or quantify bias in machine learning models 114, monitoring system 112 calculates distributions 120 of attributes 118 for qualified candidates 132 and rankings 116. Each distribution may include probabilities or proportions of different values of an attribute in the corresponding set of users. For example, a distribution of gender in a “top 100” ranking of candidates for a job may be represented as 0.4 male, 0.3 female, and 0.3 unknown. In another example, a distribution of age in all qualified candidates 132 for a job may be represented as 0.05 for an age range of 18-25, 0.35 for an age range of 26-35, 0.25 for an age range of 36-45, 0.2 for an age range of 46-55, 0.10 for an age range of 56-65, and 0.05 for an age range of 66 and over. Thus, distributions 120 may be calculated by dividing the number of candidates in a particular set of candidates (e.g., a ranking of candidates or a set of qualified candidates 132) with each value (or range of values) of a given attribute by the total number of candidates in the set.

Next, monitoring system 112 uses distributions 120 to calculate a set of metrics 122 for detecting and/or quantifying bias in machine learning models 114. In particular, monitoring system 112 may calculate metrics 122 from a first distribution of an attribute in a ranking (e.g., rankings 116) of recommended candidates from a machine learning model (e.g., machine learning models 114) and a second distribution of the attribute in a corresponding set of qualified candidates 132. As a result, metrics 122 may reflect differences in the two distributions, with a greater difference indicating higher bias in the machine learning model and a smaller difference indicating lower bias in the machine learning model.

Metrics 122 calculated by monitoring system 112 include a skew metric representing a difference between a first proportion of candidates with an attribute value in the ranking of recommended candidates and a second proportion of candidates with the same attribute value in the corresponding set of qualified candidates 132. For example, the skew metric may be calculated using the following formula:

$${Skew}_{v} @ k ( {τ}_{r} ) = {log}_{e} ( \frac{{p}_{{τ}_{r}^{k} , r , v}}{{p}_{q , r , v}} )$$

In the above formula, τᵣ represents a ranking of recommended candidates generated by a machine learning model (e.g., machine learning models 114) in response to a request r (e.g., request 130), and Skewν@k represents a value of the skew metric that is calculated from the top “k” candidates in the ranking. p_{τ}_{ᵣ}_{^{k}}^{,r,υ} represents the proportion of the top k candidates in the ranking with an attribute value of ν, and p_{q,r,υ} represents the proportion of candidates in the set of qualified candidates q with the same attribute value.

As a result, the skew metric may be calculated as the logarithmic ratio of the proportion of the top k candidates in the ranking with the attribute value to the corresponding proportion of candidates with the attribute value in the set of qualified candidates. A negative value of the skew metric represents a lower representation of candidates with the attribute value in the top k candidates of the ranking, and a positive value of the skew metric represents a higher representation of candidates with the attribute value in the top k candidates of the ranking. The value of k may be selected to reflect important subsets of the ranking, such as the first page of results from the ranking (e.g., a page containing the top 25 candidates in the ranking).

The skew metric may utilize the logarithm to allow skew on either side to be symmetric with respect to the ratio of the two proportions. For example, a ratio of 0.5 or 2 between the proportion of the top k candidates with the attribute value in the ranking and the corresponding proportion of candidates with the attribute value in the set of qualified candidates may result in the same magnitude and opposite signs in the skew metric. The numerator and denominator of the ratio may optionally be required to have a minimum small constant value to prevent the logarithm from evaluating to an undefined value.

Calculation of the skew metric may be illustrated using an example request for candidates that match a title of “attorney” and that reside in the greater New York City area. The set of qualified candidates 132 for the request may include 32,000 males and 48,000 females for a total of 80,000 qualified candidates 132, and the top 100 candidates in a ranking generated by a machine learning model in response to the request may include 20 males and 80 females. Thus, Skewₘₐₗₑ@ 100=log((20/100)/(32,000/80,000))=log(0.5), or approximately −0.3. The skew metric may thus indicate that males in the top 100 candidates of the ranking are underrepresented by about 50% when compared with the proportion of males in qualified candidates 132.

To further assess skew in distributions 120 of attributes 118 between the ranking and qualified candidates 132, monitoring system 112 may calculate values of the skew metric for varying numbers of k in the ranking and aggregate the skew metric values into a cumulative skew of the attribute's value. For example, the cumulative skew may be calculated using the following formula:

$${NDCS}_{v} ( {τ}_{r} ) = \frac{1}{Z} {\sum }_{i = 1}^{\vert {τ}_{r} \vert} \frac{1}{{log}_{2} ( i + 1 )} {log}_{e} ( \frac{{p}_{{τ}_{r}^{i} , r , v}}{{p}_{q , r , v}} ) , \\ where$$

$$Z = {\sum }_{i = 1}^{\vert {τ}_{r} \vert} \frac{1}{{log}_{2} ( i + 1 )} .$$

In the above formula, a normalized discounted cumulative skew (NDCS) is calculated from the ranking τᵣ for a given attribute value ν. The NDCS aggregates values of the skew metric for all possible values of k (i.e., from 1 to the size of the ranking). Each value of the skew metric is weighted based on the corresponding value of k used to produce the value, such that skew metrics that are calculated from the top few candidates in the ranking are weighted more than skew metrics that are calculated from a larger set of top candidates in the ranking. Such weighting of the skew metrics may reflect the effect of a candidate's position in the ranking on any outcomes (e.g., subsequent communication with the candidate or evaluation of the candidate for an opportunity) associated with the ranking.

Unlike the skew metric, the NDCS can be calculated for rankings of different sizes and can be improved by reranking the top k results. On the other hand, the NDCS can only be used to assess the cumulative skew of a single attribute value instead of measuring bias over multiple attribute values.

To allow bias across multiple values of an attribute to be analyzed for a given ranking and corresponding set of qualified candidates 132, monitoring system 112 also calculates a divergence metric representing a divergence of a first distribution of the attribute in the ranking from a second distribution of the attribute in the set of qualified candidates 132. A higher value for the divergence metric may indicate a greater divergence of the first distribution from the second distribution, while a lower value for the divergence metric may indicate a smaller divergence of the first distribution from the second distribution.

For example, the divergence metric may be calculated using the following formula:

$$NDKL ( {τ}_{r} ) = \frac{1}{Z} {\sum }_{i = 1}^{\vert {τ}_{r} \vert} \frac{1}{{log}_{2} ( i + 1 )} {d}_{KL} ( {D}_{{τ}_{r}^{i}} \vert \vert {D}_{C ( r )} ) ,$$

where

$${d}_{KL} ( {D}_{1} \vert \vert {D}_{2} ) = {Σ}_{j} {D}_{1} ( j ) {log}_{e} \frac{{D}_{1} ( j )}{{D}_{2} ( j )}$$

represents the Kullback-Leibler (KL) divergence of distribution D₁ (the distribution of the attribute in the ranking) from distribution D₂ (the distribution of the attribute in the corresponding set of qualified candidates 132) and

$$Z = {\sum }_{i - 1}^{\vert {τ}_{r} \vert} \frac{1}{{log}_{2} ( i + 1 )} .$$

Alternatively, the divergence metric may be calculated by substituting the Jensen-Shannon (JS) divergence for the KL divergence in the above formula. The JS divergence may be calculated using the following:

d_{JS}(D₁∥D₂)=½d_{KL}(D₁∥M)+½d_{KL}(D₂∥M),

where M=½(D₁+D₂).

After distributions 120 and/or metrics 122 are calculated, monitoring system 112 uses metrics 122 to detect and mitigate bias in machine learning models 114. For example, monitoring system 112 may identify bias in a machine learning model when the skew metric and/or divergence metric for a ranking outputted by the machine learning model exceeds a threshold. Monitoring system 112 may output the skew metric and/or divergence metric in one or more tables, files, notifications, and/or visualizations. Monitoring system 112 may also track and update the values and/or visualizations as a bias-mitigation technique is applied to the ranking and/or machine learning model. As a result, metrics 122 may be used to characterize bias in the machine learning model and/or assess the effectiveness of the bias-mitigation technique on the output of the machine learning model.

Monitoring system 112 may also, or instead, assess bias in the machine learning model by directly comparing the distribution of attributes 118 in the ranking with the distribution of attributes 118 in the corresponding set of qualified candidates 132. During comparison of the two distributions (e.g., distributions 120), monitoring system 112 may identify an underrepresented group in the ranking that indicates machine learning model bias when the proportion of a certain attribute value in the ranking is lower than the proportion of the same attribute value in the set of qualified candidates 132. For example, qualified candidates 132 may have a gender distribution that is 60% male and 40% female. As a result, the ranking may have an underrepresented female group if the gender distribution in the ranking is 70% male and 40% female. Conversely, the ranking may have an underrepresented male group if the gender distribution in the ranking is 50% male and 50% female.

When bias is found in the machine learning model, monitoring system 112 determines target proportions 124 of one or more attributes 118 that improve representation of the attribute(s) in rankings 116 outputted by the machine learning model. Each target proportion represents a minimum proportion of candidates with a corresponding attribute value to be achieved in a given ranking. The target proportion may be obtained as the proportion of qualified candidates 132 with the attribute and/or as a user-specified parameter (e.g., a legal requirement and/or voluntary commitment).

A tolerance factor may optionally be applied to the target proportion using the following formula:

p_{l,r,g}_{ᵣ}=min(1,α*p_{t,r,g}_{ᵣ})

In the above formula, a target proportion p is calculated for a ranking of candidates t, a request r, and an underrepresented group gᵣ. The target proportion is obtained as the minimum of 1 or the target proportion multiplied by a tolerance factor α. When α=1, the target proportion represents statistical parity with respect to the distribution of the group in the corresponding set of qualified candidates 132 and/or a user-specified parameter. When α>1, fairness to the underrepresented group is favored over utility (i.e., the quality of the ranking). When α<1, utility is favored over fairness. Like the target proportion, the tolerance factor may be specified by a user and/or legal requirement.

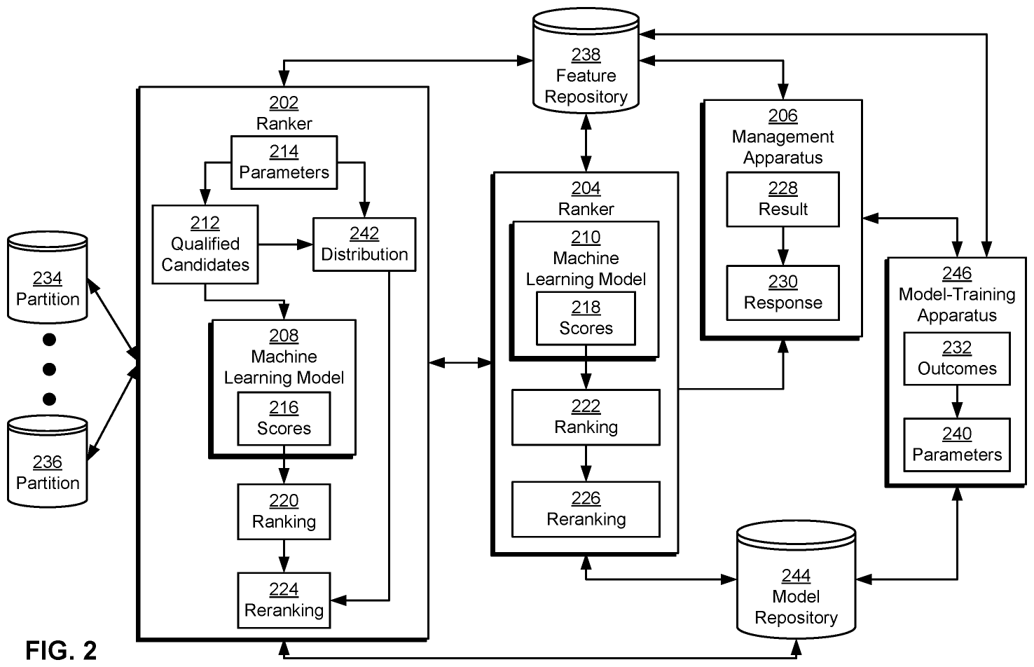

Next, monitoring system 112 generates one or more rerankings 126 to achieve the target proportions 124 of attributes 118 for the corresponding rankings 116. For example, monitoring system 112 may perform one or more levels of ranking and reranking of candidates to generate a set of results for a search request, as described in further detail below with respect to FIG. 2. In addition, monitoring system 112 may employ various reranking techniques to produce rerankings 126 from rankings 116.

First, monitoring system 112 may perform reranking of candidates based on two possible values of an attribute when one value belongs to an underrepresented group in a ranking. During such reranking, multiple values of the attribute may be grouped into the underrepresented value and all other values. For example, an attribute for gender may be grouped into an underrepresented value of “female” and all other values that include “male” and “unknown.” In another example, an attribute for age may be grouped into an underrepresented value of “older than 40” and all other ages (i.e., younger than 40).

Monitoring system 112 uses the two possible values of the attribute to generate, from the biased ranking outputted by a machine learning model, a first attribute-specific ranking of recommended candidates with the underrepresented attribute value and a second attribute-specific ranking of recommended candidates without the underrepresented attribute value. Like the original ranking, both rankings may order the recommended candidates by descending score from the machine learning model.

Next, monitoring system 112 performs a reranking of the recommended candidates by sequentially selecting a candidate to fill each position of the reranking, starting at the top of the reranking and proceeding to the bottom of the reranking. At each position, monitoring system 112 calculates a minimum number of candidates required to maintain the target proportion of the underrepresented attribute value from the top of the reranking to that position. Monitoring system 112 then moves a candidate with a highest score from one of the rankings based on the minimum number of candidates and scores of the top-ranked candidates in each attribute-specific ranking.

For example, reranking of candidates based on two possible values of an attribute may be implemented using the following:

Input: Request r; Number of desired items k: Original ranking τᵣ; Target

proportion of underrepresented group Pt,r,gᵣ; Tolerance function β

Output: A ranked list \tilde{τ} of up to k items
For i ∈ {1, . . . , k}, m[i] := max(0, └Pt,r,gᵣ · i − β(i)┘).
Compute two ranked lists, each of (up to) size k, of candidates
having value gᵣ (τ_{r,}gᵣ) and not having value gᵣ (τᵣ,g̅ᵣ̅).
nDisadv := 0; nRest := 0
while nDisadv + nRest < k do

if nDisadv < m[nDisadv + nRest + 1] then

if τᵣ,gᵣ = ϕ then

return \tilde{τ}

nDisadv := nDisadv + 1
\tilde{τ}[nDisadv + nRest] := pop(τᵣ,gᵣ)

else

if Q(head(τᵣ,gᵣ), r) ≥ Q(head(τᵣ,g̅ᵣ̅), r) then

if τᵣ,gᵣ = ϕ then

return \tilde{τ}

nDisadv := nDisadv + 1
\tilde{τ}[nDisadv + nRest] := pop(τᵣ,gᵣ)

else

nRest := nRest + 1
\tilde{τ}[nDisadv + nRest] pop(τᵣ,g̅ᵣ̅)

return \tilde{τ}

The example implementation above begins by calculating the minimum number of candidates with the underrepresented attribute value to be included up to each position (from 1 to k) in the reranking to maintain the target proportion. The minimum number may be calculated by applying a tolerance factor β to the product of the target proportion and the number of candidates at position number i. The tolerance factor may be a constant or a function of i (e.g., β(i)=i/25 allows the minimum number to be discounted by 1 every 25 positions in the reranking).

Next, the implementation computes two attribute-specific rankings, one containing candidates from the underrepresented group and one containing all other candidates. Each attribute-specific ranking may include an ordering of candidates by descending score from the machine learning model.

The implementation then generates the reranking in a way that reflects the scores of the candidates while respecting the minimum requirements for the underrepresented attribute value at each position. In particular, the implementation selects the highest-scoring candidate from both attribute-specific rankings for a given position in the reranking when the minimum number of candidates with the underrepresented attribute value has already been met for the position. When the minimum number of candidates can only be met by including a candidate with the underrepresented attribute value in the position, the highest-scoring candidate from the attribute-specific ranking containing the underrepresented attribute value is moved to the position.

Monitoring system 112 also includes functionality to generate rerankings 126 based on target proportions 124 for multiple attribute values. For example, monitoring system 112 may obtain target proportions 124 for a given ranking outputted by a machine learning model from proportions of the attribute values in a corresponding set of qualified candidates 132. In another example, monitoring system 112 may obtain target proportions 124 as user-specified parameters. In a third example, target proportions 124 may be scaled and/or modified using a tolerance factor.

Next, monitoring system 112 generates a set of attribute-specific rankings from the ranking outputted by a machine learning model. Each attribute-specific ranking may include candidates with a common attribute value from the multiple attribute values associated with target proportions 124. For example, monitoring system 112 may generate, for a gender attribute with values of “male,” “female,” and “unknown,” a first attribute-specific ranking of recommended candidates with the “male” attribute value, a second attribute-specific ranking of recommended candidates with the “female” attribute value, and a third attribute-specific ranking of recommended candidates with the “unknown” attribute value. Candidates in each attribute-specific ranking may be ordered by descending score outputted by the machine learning model.

Monitoring system 112 then generates a reranking using the set of attribute-specific rankings and ranking criteria associated with target proportions 124. More specifically, monitoring system 112 may use a number of techniques to generate the reranking based on target proportions 124 for multiple attribute values. First, monitoring system 112 may employ a greedy reranking technique that sequentially selects a candidate to fill each position of the reranking, beginning at the top of the reranking and proceeding until the bottom of the reranking is reached. At each position, monitoring system 112 uses target proportions 124 to calculate a minimum number of candidates required to maintain the target proportion of each attribute value from the top of the reranking to the position. Monitoring system 112 may optionally use target proportions 124 and/or other values to calculate a maximum number of candidates with each attribute value that can be included from the top of the reranking to the position. When the minimum number of candidates is not met for one or more attribute values, monitoring system 112 moves a candidate with the highest score from attribute-specific rankings containing the attribute value(s) to the position. When the minimum number of candidates is met for all attribute values, monitoring system 112 moves the candidate with the highest score and an attribute value that falls below the corresponding maximum number to the position.

For example, the greedy reranking technique may be implemented using the following:

Input:

| | |
|---|---|
| • | a: k attribute values indexed as a_i, each attribute value having n |

elements with score s_{i,j}.

| | |
|---|---|
| ∘ | The element list is ordered, i.e. a_{i,j} refers to j^{\hat{ }}{th} element |

of attribute value a_{i}, with score s_{i,j}.

| | |
|---|---|
| ∘ | for all m, n: m < n <−> s_{i,m} <= s_{i,n} |

| • | p: A multinomial distribution where p_i indicates the target |
|---|---|
| | proportion (empirical probability) of attribute value a_i |
| • | rec_max: Maximum number of recommendations |

Output: an ordered list of scores and attribute value ids
counts_so_far = [0 for each a_i in a]
ranked_attribute_list = [ ]
ranked_score_list = [ ]
for each index ind up to rec_max:

below_minimums = [a_i where counts_so_far[a_i] < floor(ind * p_i)]
below_maximums = [a_i where

counts_so_far[a_i] >= floor(ind * p_i) and
counts_so_far[a_i] < ceil(ind * p_i)]

if below_minimums is not empty:

next_attribute = argmax_{a_i in below_minimums}

s_{i, counts_so_far[i]}

else:

next_attribute = argmax_{a_i in below_maximums}

s_{i, counts_so_far[i]}

ranked_attribute_list[ind] = next_attribute
ranked_score_list[ind] = s_{next_attribute,

counts_so_far[next_attribute]}

counts_so_far[next_attribute]++

return [ranked_attribute_list, ranked_score_list]

At each position (“index”) of the reranking, the example implementation determines a set of rankings represented by “below_minimums” that are below their minimum candidate numbers (represented by integer floors) for meeting the corresponding target proportions. The implementation also determines a set of rankings represented by “below_maximums” that are below their maximum candidate numbers (represented by integer ceilings) allowed up to the position. If “below_minimums” is not empty, the implementation moves the highest-scoring candidate from “below_minimums” to the position. If “below_minimums” is empty, the implementation moves the highest-scoring candidate from “below_maximums” to the position. The implementation repeats the process until the maximum number of recommendations (“rec_max”) is reached.

Alternatively, monitoring system 112 may use a look-ahead technique to select a candidate for a position when minimum candidate numbers are met for all attribute values. The look-ahead technique may determine, for each attribute value with a target proportion, the fractional number of candidates between the position and a subsequent position at which the minimum number of candidates with the attribute value increases. The technique may then select a highest-scoring candidate with an attribute value that has the lowest fractional number of candidates between the position and the subsequent position.

For example, the look-ahead technique may be implemented using the following:

Input:

| | |
|---|---|
| • | a: k attribute values indexed as a_i, each attribute value having n |

elements with score s_{i,j}.

| ∘ | The element list is ordered, i.e. a_{i,j} refers to j^{\hat{ }}{th} element |
|---|---|
| | of attribute value a_{i}, with score s_{i,j}. |
| ∘ | for all m, n: m < n <−> s_{i,m} <= s_{i,n} |

| • | p: A multinomial distribution where p_i indicates the target |
|---|---|
| | proportion (empirical probability) of attribute value a_i |
| • | rec_max: Maximum number of recommendations |

Output: an ordered list of scores and attribute value ids
counts_so_far = [0 for each a_i in a]
ranked_attribute_list = [ ]
ranked_score_list = [ ]
for each index ind up to rec_max:

below_minimums = [a_i where counts_so_far[a_i] < floor(ind * p_i)]
below_maximums = [a_i where

counts_so_far[a_i] >= floor(ind * p_i) and
counts_so_far[a_i] < ceil(ind * p_i)]

if below_minimums is not empty:

next_attribute = argmax_{a_i in below_minimums}

s_{i, counts_so_far[i]}

else:

next_attribute = argmin_{a_i in below_maximums}

(ceil(ind * p_i) − counts_so_far[i]) / p_i

ranked_attribute_list[ind] = next_attribute
ranked_score_list[ind] = s_{next_attribute,

counts_so_far[next_attribute]}

counts_so_far[next_attribute]++

return [ranked_attribute_list, ranked_score_list]

Like the greedy reranking technique, the example implementation of the look-ahead technique moves the highest-scoring candidate from “below_minimums” to the position if “below_minimums” is not empty. If “below_minimums” is empty, the implementation moves a candidate with an attribute value that will reach the corresponding minimum candidate number in the fewest fractional positions (calculated using “(ceil(ind*p_i)−counts_so_far[i])/p_i”) to the position.

A relaxed variation of the look-ahead technique may use the integer number of candidates between the position and a subsequent position at which the minimum candidate number for each attribute value increases to select the candidate at a given position of the reranking. For example, the relaxed variation may include the following implementation:

Input:

| | |
|---|---|
| • | a: k attribute values indexed as a_i, each attribute value having n |

elements with score s_{i,j}.

| ∘ | The element list is ordered, i.e. a_{i,j} refers to j^{\hat{ }}{th} element |
|---|---|
| | of attribute value a_{i}, with score s_{i,j}. |
| ∘ | for all m, n: m < n <−> s_{i,m} <= s_{i,n} |

| • | p: A multinomial distribution where p_i indicates the target |
|---|---|
| | proportion (empirical probability) of attribute value a_i |
| • | rec_max: Maximum number of recommendations |

Output: an ordered list of scores and attribute value ids
counts_so_far = [0 for each a_i in a]
ranked_attribute_list = [ ]
ranked_score_list = [ ]
for each index ind up to rec_max:

below_minimums = [a_i where counts_so_far[a_i] < floor(ind * p_i)]
below_maximums = [a_i where

counts_so_far[a_i] >= floor(ind * p_i) and
counts_so_far[a_i] < ceil(ind * p_i)]

if below_minimums is not empty:

next_attribute = argmax_{a_i in below_minimums} s_{i,
counts_so_far[i]}

else:

min_fractional_steps = min([ceil((ceil(ind * p_i) −

counts so far[i]) / p_i) for a_i in below maximums ])

min_fractional_step_attributes = [a_i in below_maximums

where ceil((ceil(ind * p_i) − counts_so_far[i]) / p_i) ==
min_fractional_steps]

next_attribute = argmax_{a_i in

min_fractional_step_attributes}
s_{i, counts_so_far[i]}

ranked_attribute_list[ind] = next_attribute
ranked_score_list[ind] = s_{next_attribute,

counts_so_far[next_attribute]}

counts_so_far[next_attribute]++

return [ranked_attribute_list, ranked_score_list]

The example implementation above moves the highest-scoring candidate from “below_minimums” to the position if “below_minimums” is not empty. If “below_minimums” is empty, the implementation applies a ceiling function to the fractional number of positions before the minimum candidate number of each attribute value increases (i.e., “ceil((ceil(ind*p_i)−counts_so_far[i])/p_i)”) to obtain the corresponding integer number of positions for the attribute value. Because multiple attribute values can have the same integer number of positions before their minimum candidate numbers increase, the implementation can select a candidate with the highest score from multiple attribute-specific rankings for the attribute values for the position.

The operation of the reranking techniques described above may be illustrated using the following example attribute-specific rankings:

Male (target proportion 0.3): 0.6, 0.5, 0.35, 0.15, 0.05

Female (target proportion 0.4): 0.7, 0.4, 0.3, 0.25, 0.23

Unknown (target proportion 0.2): 0.5, 0.45, 0.2, 0.1, 0.02

The rankings above may represent gender attribute values of “Male, “Female,” and “Unknown.” The “Male” attribute value has a target proportion of 0.35, the “Female” attribute value has a target proportion of 0.4, and the “Unknown” attribute value has a target proportion of 0.25. Each ranking includes a set of ordered scores for the corresponding gender.

The top seven positions in the reranking include the top three “Male” candidates, the top two “Female” candidate, and the top two “Unknown” candidates. At the eighth position, the number of “Female” candidates in the ranking drops below the minimum number of “Female” candidates (floor(8*0.4), or 3) required to maintain the target proportion of 0.4. As a result, the highest-scoring “Female” candidate that is not already in the reranking (i.e., the candidate with the score of 0.3 in the “Female” ranking) may be selected for the eighth position.

At the ninth position, the reranking includes three “Male” candidates, three “Female” candidates, and two “Unknown” candidates. The “Male” attribute value has a minimum candidate number of floor(9*0.35), or 3; the “Female” attribute value have a minimum candidate number of floor(9*0.4), or 3; and the “Unknown” attribute value has a minimum candidate number of floor(9*0.25), or 2. Because the minimum candidate number has already been met for all of the attribute values, the greedy reranking technique selects the highest-scoring candidate from all three rankings (the “Female” with the score of 0.25) for the ninth position.

On the other hand, either variation of the look-ahead technique may calculate the number of candidates between the ninth position and a subsequent position at which the minimum candidate number increases for each attribute value. The “Male” attribute value has a fractional position of 4/0.35, or 11.4, which is rounded to 12 in the relaxed variation; the “Female” attribute value has a position of 4/0.4, or 10; and the “Unknown” attribute has a number of 3/0.25, or 12. Because the “Female” attribute has the lowest fractional or integer number of candidates between the ninth position and a subsequent position (10) with an increase in the corresponding minimum candidate number, the highest-scoring “Female” candidate that is not already in the reranking is selected for the ninth position (i.e., the candidate with the score of 0.25 in the “Female” ranking).

At the tenth position, the reranking includes three “Male” candidates, four “Female” candidates, and two “Unknown” candidates. The “Male” attribute value has a fractional number of 4/0.35, or 11.4, which is rounded to 12 in the relaxed variation; the “Female” attribute value has a fractional number of 5/0.4, or 12.5, which is rounded to 13 in the relaxed variation; and the “Unknown” attribute value has a fractional or integer number of 3/0.25, or 12. The fractional version of the look-ahead technique may choose the highest-scoring “Male” candidate that is not already in the ranking (i.e., the candidate with the score of 0.15 in the “Male” ranking). On the other hand, the relaxed version of the look-ahead technique may choose the candidate with the highest score from the “Male” and “Unknown” rankings, or the “Unknown” candidate with the score of 0.2, which is higher than the “Male” candidate's score of 0.15 (and thus provides better utility than the fractional version).

Monitoring system 112 may also, or instead, employ a non-deterministic approach in generating a reranking of recommended candidates from a ranking outputted by a machine learning model. The non-deterministic approach may start at the top of the reranking and calculate a distribution of the attribute values for each position in the reranking. The distribution may be based on target proportions 124, scores of the highest-ranked candidates in rankings associated with specific attribute values, and/or current proportions of the attribute values in the reranking up to the position. The approach may then randomly select a candidate for the position according to the distribution.

For example, the non-deterministic approach may include the following implementation:

Input:

| | |
|---|---|
| • | a: k attribute values indexed as a_i, each attribute value having n |

elements with score s_{i,j}.

| ∘ | The element list is ordered, i.e. a_{i,j} refers to j^{\hat{ }}{th} element |
|---|---|
| | of attribute value a_{i}, with score s_{i,j}. |
| ∘ | forall m, n: m < n <−> s_{i,m} <= s_{i,n} |

| • | p: A multinomial distribution where p_i indicates the target |
|---|---|
| | proportion (empirical probability) of attribute value a_i |
| • | rec_max: Maximum number of recommendations |
| • | beta: A hyper-parameter in [0, 1] utilized to modify sampling |

probability.

Output: an ordered list of scores and attribute value ids
counts_so_far = [0 for each a_i in a]
ranked_attribute_list = [ ]
ranked_score_list = [ ]
for each index ind up to rec_max:

current_distribution = [c_i / sum(counts_so_far) for c_i in

counts_so_far]

new_sampling_distribution = [p_i * s_{i, counts_so_far[i]}

for a_i in a]

if index > 1:

delta = pow(beta, index − 1)
new_sampling_distribution = [p_i * ((current_distribution[i] +

delta) / (p_i + delta)) * s_{i, counts_so_far[i]}
for a_i in a]

next_attribute =

sample_from(normalized(new_sampling_distribution))

ranked_attribute_list[ind] = next_attribute
ranked_score_list[ind] = s_{next_attribute,

counts_so_far[next_attribute]}

counts_so_far[next_attribute]++

return [ranked_attribute_list, ranked_score_list]

The above implementation calculates a “current_distribution” of each attribute value from the top of the reranking to a current position in the reranking. The implementation then calculates a “new_sampling_distribution” that combines the target proportion of each attribute value with the score of the highest-ranked candidate with that attribute value. If the position is not the first position, the implementation calculates a value of “delta” by raising a “beta” hyperparameter ranging from 0 to 1 (which can be a function of the position) to the power of the current position number minus 1. The implementation updates “new_sampling_distribution” by multiplying the target proportion for each attribute value by the difference between the current proportion of the attribute value and the target proportion and the score of the highest-ranked candidate with the attribute value. In “new_sampling_distribution,” “delta” may used to control the effect of the current proportion of the attribute on the distribution. If the position is the first position, the implementation does not update “new_sampling_distribution.”

The implementation then selects a candidate for the position by randomly sampling from a normalized vector containing “new_sampling_distribution.” When an attribute value is chosen from the normalized vector, the highest-scoring candidate with the attribute value is moved from the corresponding ranking to the position in the reranking. A given candidate may have a higher chance of being selected when the candidate has a higher score, the candidate's attribute value has a higher target proportion, and/or the current proportion of the attribute value is lower than the target proportion.

Finally, monitoring system 112 may use an interval constrained sorting technique to generate a reranking of recommended candidates from a ranking outputted by a machine learning model. Unlike previous approaches, the interval constrained sorting technique may add candidates to positions in the reranking in a non-sequential fashion and reorder candidates in the reranking based on constraints associated with target proportions 124 and/or scores of the candidates.

More specifically, the interval constrained sorting technique may be represented by the following expression:

maximize sum(1/log(r_i+1.0))*s_i,such that
for all j and k, r_j !=r_k, and
for all j, r_j<=m_j<=|o|
   In the above expression, r_i represents the assigned position of the i^{th} candidate, s_i is the score of the i^{th} candidate, m_i is the lowest position that the i^{th} candidate can be at without causing the corresponding attribute value to fall below the minimum candidate number, and |o| is the total number of candidates in the reranking.

The interval constrained sorting technique may also have the following implementation:

Input:

| | |
|---|---|
| • | a: k attribute values indexed as a_i, each attribute value having n |

elements with score s_{i,j}.

| ∘ | The element list is ordered, i.e. a_{i,j} refers to j^{\hat{ }}{th} element |
|---|---|
| | of attribute value a_{i}, with score s_{i,j}. |
| ∘ | for all m, n: m < n <−> s_{i,m} <= s_{i,n} |

| • | p: A multinomial distribution where p_i indicates the target |
|---|---|
| | proportion (empirical probability) of attribute value a_i |
| • | rec_max: Maximum number of recommendations |

Output: an ordered list of scores and attribute value ids
counts_so_far = [0 for each a_i in a]
min_counts = [0 for each a_i in a]
ranked_attribute_list = [ ]
ranked_score_list = [ ]
max_indexes = [ ]
last_empty = 0
ind = 0
while last_empty <= rec_max:

| ind++ | |
|---|---|
| temp_min_counts = [floor(ind * p_i) for a_i] | |
| changed_minimums = [a_i where min_counts[a_i] < | |
| | temp_min_counts [a_i]] |
| if changed_minimums is not empty: | |

ord_changed_mins = order changed_minimums according to

descending s_{a_i, counts_so_far[a_i]}

for each a_i in ord_changed_minimums:

ranked_attribute_list[last_empty] = a_i
ranked_score_list[last_empty] = s_{ a_i,

counts_so_far[a_i]}

max_indexes[last_empty] = ind
start = last_empty
while start > 0 and max_indexes[start − 1] >= start

and ranked_score_list[start−1] <

ranked_score_list[start]:

swap(max_indexes[start − 1],

max_indexes [start])

swap(ranked_attribute_list[start − 1],

ranked_attribute_list[start])

swap(ranked_score_list[start − 1],

ranked_score_list[start])

start−−

counts_so_far[a_i]++
last_empty++

min_counts = temp_min_counts

return [ranked_attribute_list, ranked_score_list]

The implementation begins with an empty reranking and increments a counter representing a position in the reranking until the minimum candidate number for one or more attribute values has increased. If more than one attribute value has a minimum candidate number that has increased, the implementation orders the attribute values by descending score of the highest-ranked candidate with each attribute value. The implementation then inserts the highest-ranked candidates into the reranking according to the ordering. When a candidate is added to the reranking, the candidate is inserted into the first empty position in the reranking, and the lowest position that the candidate can be at without causing the candidate's attribute value to fall below the minimum candidate number is stored in “max_indexes.” The candidate is then swapped toward earlier positions until the score of another candidate with a higher position in the reranking is higher than the candidate's score and/or the other candidate is already at the corresponding lowest position that maintains the minimum candidate number for the other candidate's attribute value.

The operation of the interval constrained sorting technique may be illustrated using the following rankings:
Male (target proportion 0.35): 0.6, 0.5
Female (target proportion 0.4): 0.8, 0.7
Unknown (target proportion 0.2): 0.9, 0.45
   At the first and second positions in the reranking, all three attribute values have minimum candidate numbers of 0. At the third position of the reranking, both the “Male” and “Female” attribute values have increased minimum candidate numbers of 1. As a result, the top-ranked “Male” and “Female” candidates may be inserted into the reranking according to the corresponding scores, resulting in the top-ranked “Female” candidate with a score of 0.8 occupying the first position of the reranking and the top-ranked “Male” candidate with a score of 0.6 occupying the second position of the reranking. Both candidates are also assigned a lowest position of 3 for their respective attribute values.

At the fourth position in the reranking, the “Unknown” attribute value has an increased minimum candidate number of 1. As a result, the top-ranked “Unknown” candidate with a score of 0.9 may be inserted into the third position in the reranking and swapped with earlier positions in the reranking until the “Unknown” candidate reaches the first position in the reranking, the “Female” candidate with the score of 0.8 is in the second position, and the “Male” candidate with the score of 0.6 is in the third position. The “Unknown” candidate is also assigned a lowest position of 4 for the respective attribute value.

At the fifth position in the reranking, the “Female” attribute value has an increased minimum candidate number of 2. In turn, the “Female” candidate with a score of 0.7 is inserted into the fourth position in the reranking. While the candidate has a higher score than the “Male” candidate with the score of 0.6 in the third position, the two candidates cannot be swapped because the “Male” candidate is already at the lowest position that still meets the minimum candidate number of 1 in the first three positions of the ranking. As a result, the candidate may remain at the fourth position and be assigned a lowest position of 5 for the “Female” attribute value.

After one or more rerankings 126 of recommended candidates are generated for a given request, monitoring system 112 outputs at least a portion of the reranking(s) in a response to the request. For example, monitoring system 112 may select a certain number of top-ranked candidates (e.g., the top 25, 50, 100, etc.) for inclusion in the response and transmit the response to application 110 and/or a user of application 110. In turn, application 110 and/or the user may view the candidates in the response and take subsequent action related to the response (e.g., contacting one or more candidates, extending connection invitations to the candidate(s), recommending jobs and/or other opportunities to the candidate(s), etc.).

Monitoring system 112 may also, or instead, recalculate metrics 122 using rerankings 126 to compare bias between rerankings 126 and the original rankings 116 and/or assess the effectiveness of different reranking techniques in increasing fairness toward underrepresented groups. For example, monitoring system 112 may compare cumulative and/or non-cumulative skew and/or divergence metrics between a ranking from a machine learning model and a corresponding reranking from monitoring system 112 to characterize the behavior and/or performance of the reranking technique used to produce the reranking. Monitoring system 112 may also generate plots, charts, histograms, and/or other visualizations of metrics 122 for the ranking and reranking to facilitate human analysis and understanding of bias in the machine learning model and/or bias mitigation performed by the reranking technique.

By calculating multiple metrics 122 from rankings 116, monitoring system 112 may provide measures for evaluating machine learning bias across different attributes, attribute values, and/or ranking sizes. At the same time, the calculation of the same metrics 122 from rerankings 126 may facilitate analysis and understanding of the effect of various reranking and/or bias-mitigation techniques on reducing the bias. Finally, rerankings 126 may be generated using multiple techniques that balance fairness and utility, thereby allowing underrepresented groups to be included at or near the corresponding target proportions 124 in rerankings 126 without significantly reducing the quality and/or value of rerankings 126. Consequently, the system of FIG. 1 may improve technologies related to online networks, machine learning models, recommendations, and/or rankings; performance and use of network-enabled devices (e.g., electronic devices 102-108) and/or applications (e.g., application 110) that access or execute the online networks, machine learning models, recommendations, and/or rankings; and/or user engagement, experience, and interaction involving the online networks, machine learning models, recommendations, and/or rankings.

Those skilled in the art will appreciate that the system of FIG. 1 may be implemented in a variety of ways. First, application 110, monitoring system 112, and/or data repository 134 may be provided by a single physical machine, multiple computer systems, one or more virtual machines, a grid, one or more databases, one or more filesystems, and/or a cloud computing system. Application 110 and monitoring system 112 may additionally be implemented together and/or separately by one or more hardware and/or software components and/or layers.

Second, a number of machine learning models 114 and/or techniques may be used to generate rankings 116. For example, the functionality of each machine learning model may be provided by a regression model, artificial neural network, support vector machine, decision tree, random forest, gradient boosted tree, naïve Bayes classifier, Bayesian network, clustering technique, collaborative filtering technique, deep learning model, hierarchical model, and/or ensemble model. The retraining or execution of each machine learning model may be performed on an offline, online, and/or on-demand basis to accommodate requirements or limitations associated with the processing, performance, or scalability of the system and/or the availability of features used to train the machine learning model. Multiple versions of a machine learning model may further be adapted to different subsets of request parameters and/or candidates, or the same machine learning model may be used to generate scores and/or rankings 116 for all candidates and/or requests 130. Similarly, one or more rounds of ranking may be performed by multiple machine learning models 114 with one or more rounds of reranking by monitoring system 112 before a response to a corresponding request is generated.

Third, various reranking techniques may be utilized and/or combined to generate rerankings 126. For example, different reranking techniques may be used to select different subsets of positions in a reranking. In another example, multiple reranking techniques may be applied to the same ranking to produce multiple rerankings 126 for a given request, and a reranking with the highest utility and/or fairness may be selected for inclusion in a response to the request. In a third example, a reranking is generated from a subset of candidates in a ranking from a machine learning model, such as the number of top-ranked candidates that can be included in a first page of results displayed in response to the corresponding request.

Fourth, the system of FIG. 1 may be adapted to detect and mitigate bias for various types of requests and/or entities. For example, the functionality of the system may be used to improve fairness in search results and/or recommendations containing candidates for academic positions, artistic or musical roles, school admissions, fellowships, scholarships, competitions, club or group memberships, matchmaking, and/or other types of opportunities.

FIG. 2 shows a multi-level ranking architecture for mitigating bias in machine learning models in accordance with the disclosed embodiments. The architecture includes a number of rankers 202-204, a management apparatus 206, and a model-training apparatus 246. Each of these components is described in further detail below.

A first ranker 202 processes a request (e.g., requests 130 of FIG. 1) based on parameters 214 of the request. For example, the request may specify desired and/or required attributes of candidates for an opportunity. As a result, parameters 214 may include characteristics of the candidates that are desired or required for the opportunity, such as (but not limited to) a location, industry, title, skill, school, degree, company, work experience, seniority, keywords, awards, publications, patents, and/or licenses and certifications.

Ranker 202 uses a set of partitions 234-236 to process the request. For example, partitions 234-236 may store profile data, activity data, and/or other data in a data repository (e.g., data repository 134 of FIG. 1) that is queried during processing of the request. Data in the data repository may be divided among partitions 234-236 so that each partition contains data for a subset of candidates. For example, members of an online network and/or other candidates for the opportunities may be assigned to different partitions 234-236 based on ranges of member identifiers for the members, hashes calculated from the identifiers and/or other attributes of the candidates, and/or another sharding or partitioning technique. Each partition may also be replicated for fault tolerance and redundancy in the data repository.

More specifically, ranker 202 performs a fan-out of the request to partitions 234-236, and each partition responds to the request with data and/or identifiers for qualified candidates 212 that match parameters 214 of the request. For example, each partition may respond to the request with all candidates in the partition that match parameters 214. Alternatively, the partition may use a static ranking of candidates in the partition to return a pre-specified number of candidates (e.g., the top 100 candidates in the static ranking) in response to the request. The static ranking may be calculated based on attributes that are generally unrelated to parameters 214 of the request, such as a profile quality, a profile completeness, an influencer status (i.e., whether a candidate is an “influencer” or not in an online network), and/or a number of followers.

Ranker 202 also uses partitions 234-236 to calculate a distribution 242 of an attribute (e.g., gender, age range, ethnicity, a combination of two or more attributes, etc.) in qualified candidates 212. For example, ranker 202 may transmit, in parallel with the initial request for qualified candidates 212 that match parameters 214, a separate request to each partition to compute distribution 242 for the subset of candidates on the partition. In turn, the partition may calculate distribution 242 from the candidates returned in response to the initial request and/or from all candidates that match parameters 214 in the partition and return distribution 242 to ranker 202.

After a set of qualified candidates 212 matching parameters 214 is received from all partitions 234-236, ranker 202 applies a machine learning model 208 to features for qualified candidates 212 from a feature repository 238 to generate scores 216 for qualified candidates 212. Ranker 202 then produces a ranking 220 of qualified candidates 212 by scores 216. For example, ranker 202 may order qualified candidates 212 in ranking 220 by descending score from machine learning model 208.

Ranker 202 then uses distribution 242 to perform a reranking 224 of qualified candidates 212 to reduce bias from machine learning model 208 in generating ranking 220. For example, ranker 202 may aggregate values of distribution 242 from partitions 234-236 into an overall distribution 242 of qualified candidates 212 for the request. Ranker 202 may then use the overall distribution 242, a tolerance factor, and/or one or more user-specified parameters to determine target proportions of one or more attribute values in ranking 220. Ranker 202 may also use one or more of the reranking techniques discussed above to generate reranking 224 based on ranking 220 and/or scores 216. In turn, reranking 224 may include a reordering of some or all candidates in ranking 220 that better conforms to the target proportions of the attributes.

A second ranker 204 obtains reranking 224 from ranker 202 and/or another data source and performs another level of ranking 222. For example, ranker 204 may use a different machine learning model 210 to generate a new set of scores 218 for some or all candidates in reranking 224, which may represent a subset of qualified candidates 212 that were inputted into machine learning model 208. Features used by machine learning model 210 may include scores 216 from machine learning model 208, positions of candidates in ranking 220 and/or reranking 224, one or more features inputted into machine learning model 208, and/or one or more features that are not inputted into machine learning model 208. The features may be obtained from ranker 202, feature repository 238, and/or another data source. As a result, scores 218 outputted by machine learning model 210 may differ from scores 216 outputted by machine learning model, and ranking 222 of the candidates by scores 218 may include a different ordering of candidates than ranking 220 and/or reranking 224.

Ranker 204 also uses target proportions of attributes from ranker 202 to generate another reranking 226 of the candidates from ranking 222. For example, ranker 204 may use the same reranking techniques as ranker 202 and/or different reranking techniques from ranker 202 to produce reranking 226 from ranking 222. As with reranking 224, reranking 226 may be performed to reduce bias in scores 218 from machine learning model 210 and/or meet target proportions associated with distribution 242. In general, various scoring, ranking, and/or reranking techniques may be used by rankers 202-204 to generate one or more rounds of scores 216-218, rankings 220-222, and/or rerankings 224-226.

Finally, management apparatus 206 outputs some or all of reranking 226 in a result 228 for the request. For example, management apparatus 206 may paginate some or all candidates in reranking 226 into subsets of result 228 that are displayed as a user scrolls through entries in result 228 and/or navigates across screens or pages containing result 228. In another example, management apparatus 206 may include some or all candidates in reranking 226 in a notification, email, message, alert, advertisement, content feed, and/or other mechanism for interacting with the user. In a third example, management apparatus 206 may output some or all candidates in reranking 226 in a file, spreadsheet, database, table, visualization, and/or other representation of structured data.

Management apparatus 206 additionally tracks a response 230 to the displayed and/or outputted result 228. For example, management apparatus 206 may track views, clicks, messages, referrals, connection invitations, and/or other actions taken by a user viewing result 228 with respect to candidates shown in result 228.

In turn, model-training apparatus 246 uses result 228 and/or response 230 to update machine learning models 208-210, features used by machine learning models 208-210, and/or other components used to generate scores 216-218, rankings 220-222, and/or rerankings 224-226. For example, model-training apparatus 246 may include response 230 and/or responses to other results from management apparatus 206 in outcomes 232 related to the results. Each outcome may include a tuple of a request, candidate, and user submitting the request (e.g., a recruiter performing a search for candidates). The outcome may be labeled as a positive training example when interaction between the user and candidate occurs (e.g., the user sends a message to the candidate and/or the candidate response to the message from the user) after the user views the candidate in a result of the request and labeled as a negative training example otherwise. Random combinations of requests, candidates, and users may also be chosen and/or generated as negative training examples. Model-training apparatus 246 may then use outcomes 232 and features and scores 216-218 used to produce the corresponding results as training data for updating parameters 230 of one or both machine learning models 208. Model-training apparatus 246 may also store updated parameter values and/or other data associated with machine learning models 208-210 in a model repository 244 for subsequent retrieval and use. In turn, one or both rankers 202-204 may obtain the latest parameter values for the corresponding machine learning models 208-210 from model repository 244 and use the parameter values to generate subsequent sets of scores 216-218, rankings 220-222, and/or rerankings 224-226.

By performing multiple levels of ranking 220-222 and reranking 224-226 of qualified candidates 212 that match parameters 214 of a request, the system of FIG. 2 may improve the quality and fairness of result 228. For example, ranker 202 may use a relatively simple machine learning model 208 to perform a first level of scoring, ranking 220, and/or reranking 224 of some or all qualified candidates 212 in a relatively efficient manner Ranker 204 may then use a more complex machine learning model 210 to perform a second level of scoring, ranking 222, and reranking 226 of a subset of qualified candidates 212, ranking 220, and/or reranking 224 before generating result 228 from reranking 226. In other words, ranker 202 may generate a coarse-grained ranking 220 and/or reranking 224 from all qualified candidates 212 returned by partitions 234-236, while ranker 204 may incur higher computational overhead to generate a more accurate or relevant ranking 222 and/or reranking 226 from a smaller set of qualified candidates 212 in reranking 224. The number of candidates scored, ranked, and/or reranked by each ranker 202-204 and/or machine learning model 208-210 may be selected to accommodate performance and/or scalability constraints associated with generating result 228 and/or other results in response to requests received by the system.

Those skilled in the art will appreciate that the system of FIG. 2 may be implemented in a variety of ways. First, rankers 202-204, management apparatus 206, model-training apparatus 246, partitions 234-236, model repository 244, and feature repository 238 may be provided by a single physical machine, multiple computer systems, one or more virtual machines, a grid, one or more databases, one or more filesystems, and/or a cloud computing system. Ranker 202-204, management apparatus 206, and model-training apparatus 246 may additionally be implemented together and/or separately by one or more hardware and/or software components and/or layers.

Second, rankers 202-204 may be configured to perform different types or amounts of ranking and/or reranking based on scores 216-218 from one or more machine learning models 208-210. For example, reranking 224 may be omitted at ranker 202, and a single round of reranking 226 may be performed after two levels of scoring and ranking 220-222 by machine learning models 208-210 to reduce latency and computational overhead associated with processing the request at the potential cost of reduced fairness in reranking 226 and result 228.

In another example, ranker 204 may perform a second level of ranking 222 and reranking 226 on a small subset of top-ranked candidates from ranking 220 and/or reranking 224, such as the top 125 candidates from ranking 220 and/or reranking 224 to populate five pages of 25 candidates each in result 228. Additional ranking 222 and reranking 226 may be performed in an on-demand basis (e.g., when the user viewing result 228 navigates beyond the fifth page of candidates). Alternatively, ranking 222 and reranking 226 may be omitted for additional candidates beyond the subset, and additional pages of candidates in result 228 may be obtained from reranking 224 to reduce computational overhead associated with processing the request.

In a third example, reranking 224 may be omitted, and ranker 204 may generate a single round of reranking 226 based on a distribution of attribute values in candidates from ranking 220 instead of a different distribution 242 of attribute values in qualified candidates 212. As a result, latency and/or overhead associated with querying partitions 234-236 for distribution 242 may be reduced at the potential cost of reduced fairness in reranking 226 and result 228.

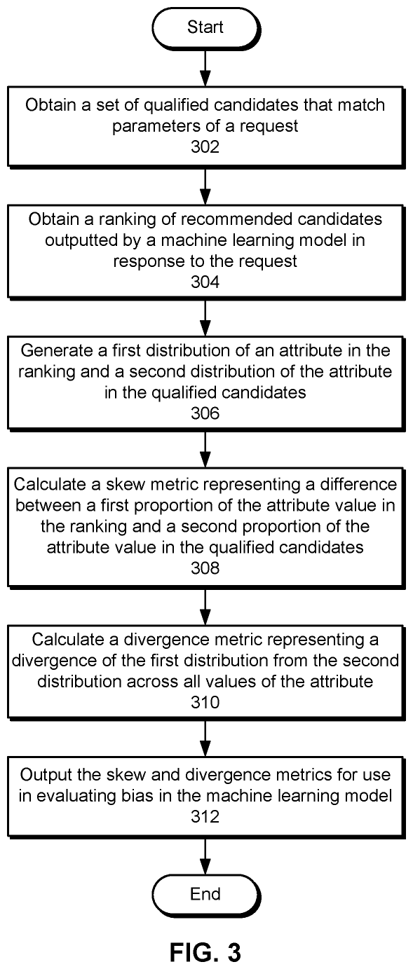

FIG. 3 shows a flowchart illustrating a process of quantifying bias in a machine learning model in accordance with the disclosed embodiments. In one or more embodiments, one or more of the steps may be omitted, repeated, and/or performed in a different order. Accordingly, the specific arrangement of steps shown in FIG. 3 should not be construed as limiting the scope of the embodiments.

Initially, a set of qualified candidates that match parameters of a request is obtained (operation 302). For example, parameters of the request may include a location, industry, title, skill, school, degree, company, work experience, seniority, keywords, awards, publications, patents, and/or licenses and certifications associated with candidates for an opportunity. The request may be transmitted to one or more partitions, and each partition may use a static ranking of candidates that match the parameters to return a pre-specified number of candidates from the static ranking as a subset of the qualified candidates.

Next, a ranking of recommended candidates outputted by a machine learning model in response to the request is obtained (operation 304). For example, the machine learning model may be applied to features for the qualified candidates to produce scores representing the strength of each candidate with respect to qualifications or requirements of the opportunity. The ranking may then be generated by ordering the candidates by descending score from the machine learning model.

A first distribution of an attribute in the ranking and a second distribution of the attribute in the qualified candidates are generated (operation 306). The attribute may include a gender, age range, ethnicity, and/or a combination of two or more attributes (e.g., gender and age range, ethnicity and gender, age range and ethnicity, etc.). Each distribution may include the proportion of different values of the attribute in the corresponding set of candidates (i.e., the set of candidates in the ranking or the set of qualified candidates obtained in operation 302).

A skew metric representing a difference between a first proportion of the attribute's value in the ranking and a second proportion of the attribute value in the qualified candidates is then calculated (operation 308) from the two distributions. For example, the first proportion may be calculated from a certain number of top-ranked candidates in the ranking of recommended candidates, and the second proportion may be calculated from the set of qualified candidates. A logarithm may then be applied to a fraction containing the first proportion divided by the second proportion to produce the skew metric. Multiple values of the skew metric may additionally be calculated for varying numbers of top-ranked candidates in the ranking of recommended candidates, and the values may be aggregated into a cumulative skew of the attribute value in the first proportion from the second proportion. During aggregation of the skew metric value into the cumulative skew, the skew values may be weighted based on the number of top-ranked candidates used to calculate each skew value.

A divergence metric representing a divergence of the first distribution from the second distribution across all values of the attribute is also calculated (operation 310). For example, values of a JS divergence and/or other measure of divergence of the first distribution from the second distribution may be calculated for varying numbers of top-ranked candidates in the ranking of recommended candidates, and the values may be aggregated into a cumulative divergence of the first distribution from the second distribution. During aggregation of the values into the cumulative divergence, the values may be weighted based on the number of top-ranked candidates used to calculate each of the values.

Finally, the skew and divergence metrics are outputted for use in evaluating bias in the machine learning model (operation 312). For example, a histogram, chart, and/or visualization containing a distribution of the skew metric and/or divergence metric across different requests may be displayed. In another example, a first value of the skew metric that is calculated prior to applying a bias-mitigation technique to the ranking may be outputted and compared to a second value of the skew metric that is calculated after the bias-mitigation technique is applied to the ranking. Consequently, the metrics may be used to detect and/or characterize bias in the machine learning model, as well as assess the effect of bias-mitigation techniques on rankings produced by the machine learning model.

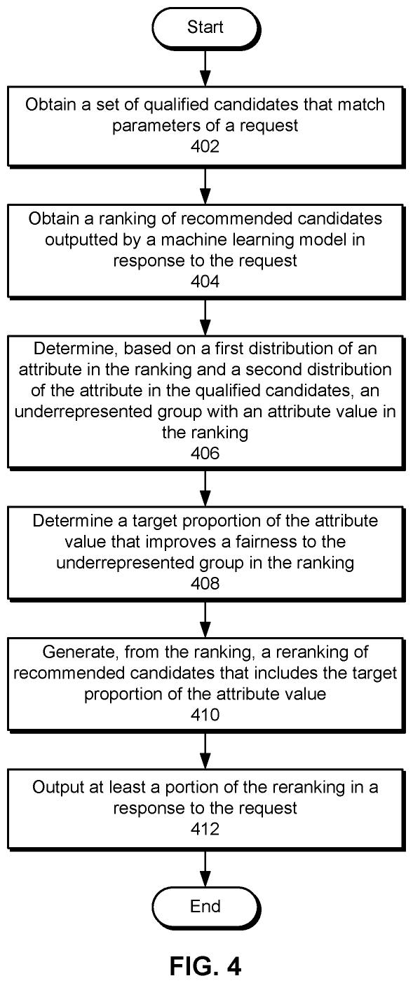

FIG. 4 shows a flowchart illustrating a process of reranking to achieve fairness in an underrepresented group in accordance with the disclosed embodiments. In one or more embodiments, one or more of the steps may be omitted, repeated, and/or performed in a different order. Accordingly, the specific arrangement of steps shown in FIG. 4 should not be construed as limiting the scope of the embodiments.

Initially, a set of qualified candidates that match parameters of a request and a ranking of recommended candidates outputted by a machine learning model in response to the request are obtained (operations 402-404), as discussed above. Next, an underrepresented group with an attribute value in the ranking is determined based on a first distribution of an attribute in the ranking and a second distribution of the attribute in the qualified candidates (operation 406). For example, the underrepresented group may be identified as a group with a negative skew metric for a given attribute value. In another example, a first proportion of the attribute value in the ranking of recommended candidates and a second proportion of the attribute value in the set of qualified candidates may be calculated, and the underrepresented group may be identified when the first proportion is lower than the second proportion.

A target proportion of the attribute value that improves a fairness to the underrepresented group in the ranking is then determined (operation 408). For example, the target proportion may be calculated from the second proportion of the attribute value in the set of qualified candidates and/or obtained as a user-specified parameter. The target proportion may also be scaled by a tolerance factor.

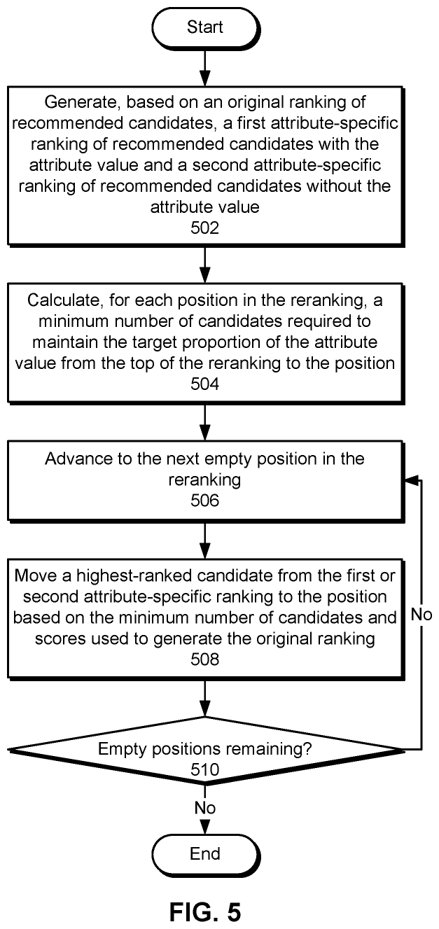

A reranking of recommended candidates that includes the target proportion of the attribute is then generated from the ranking (operation 410), as described in further detail below with respect to FIG. 5. Finally, at least a portion of the reranking is outputted in a response to the request (operation 412). For example, different subsets of the reranking may be shown in pages of search results to a user and/or application making the request.

FIG. 5 shows a flowchart illustrating a process of generating a reranking of recommended candidates that includes a target proportion of an attribute in accordance with the disclosed embodiments. In one or more embodiments, one or more of the steps may be omitted, repeated, and/or performed in a different order. Accordingly, the specific arrangement of steps shown in FIG. 5 should not be construed as limiting the scope of the embodiments.

First, a first attribute-specific ranking of recommended candidates with an attribute value and a second attribute-specific ranking of recommended candidates without the attribute value are generated based on an original ranking of recommended candidates (operation 502). For example, the original ranking may be generated based on scores outputted by a machine learning model, as described above. The ranking may be separated into the first and second attribute-specific rankings, with candidates in both rankings ordered by descending score from the machine learning model and/or positions of the candidates in the original ranking.

Next, a minimum number of candidates required to maintain the target proportion of the attribute value from the top of the reranking to a position in the reranking is calculated for each position in the reranking (operation 504). For example, the minimum number may be calculated by multiplying the target proportion by the number of candidates from the top of the reranking to the position and rounding the resulting value down to the nearest integer. A tolerance factor may optionally be applied to the minimum number to relax the minimum number of candidates for one or more positions.

The reranking is then generated by advancing to the next empty position in the reranking (operation 506) and moving a highest-ranked candidate from the first or second rankings to the position based on the minimum number of candidates and scores used to generate the ranking (operation 508). For example, the reranking may be generated by sequentially selecting a candidate for each position in the reranking, starting at the top of the reranking and proceeding to the bottom of the reranking. At a given position in the reranking, the highest-scoring candidate from both rankings may be moved to the position in the reranking when the minimum number of candidates for the position has already been met. When the minimum number of candidates can only be met by including a candidate with the attribute value in the position, the highest-scoring candidate from the first ranking containing the attribute value is moved to the position.

Operations 506-508 may be repeated while empty positions remain (operation 510) in the reranking. For example, the reranking may be generated to be the same size as the original ranking and/or smaller than the original ranking. As a result, operations 506-508 may be used to select a candidate for each position in the reranking until the end of the reranking is reached.

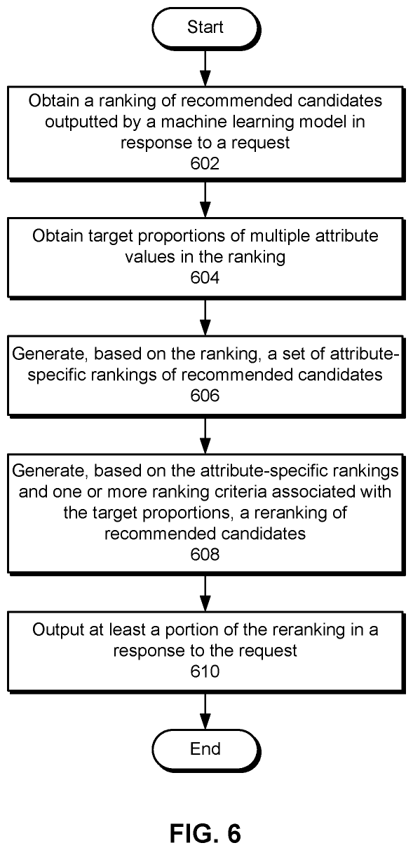

FIG. 6 shows a flowchart illustrating a process of achieving fairness across multiple attributes in rankings in accordance with the disclosed embodiments. In one or more embodiments, one or more of the steps may be omitted, repeated, and/or performed in a different order. Accordingly, the specific arrangement of steps shown in FIG. 6 should not be construed as limiting the scope of the embodiments.

Initially, a ranking of recommended candidates outputted by a machine learning model in response to a request (operation 602) and target proportions of multiple attribute values in the ranking are obtained (operation 604), as described above. Next, a set of attribute-specific rankings of recommended candidates is generated based on the ranking (operation 606).

For example, the ranking may be separated into multiple attribute-specific rankings, each containing candidates with a common attribute value. Each attribute-specific ranking may order candidates according to scores from the machine learning model and/or the positions of the candidates in the original ranking.

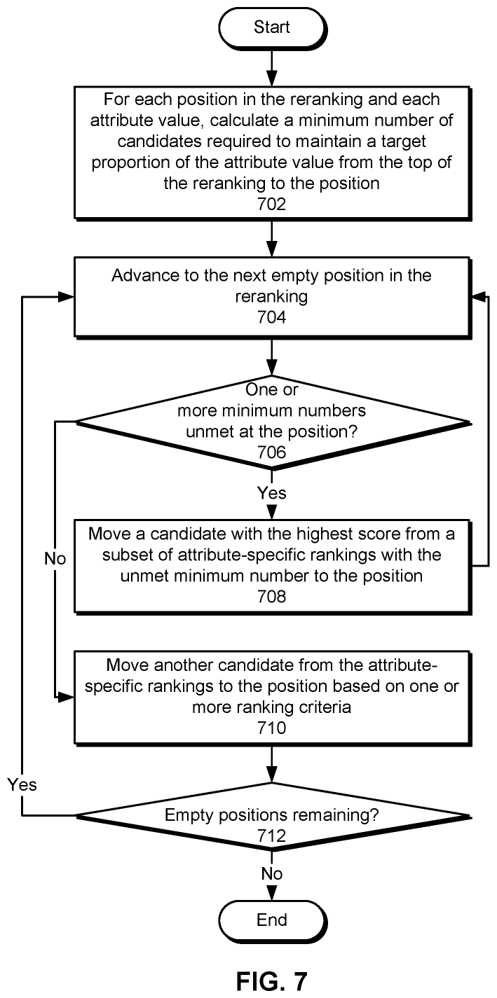

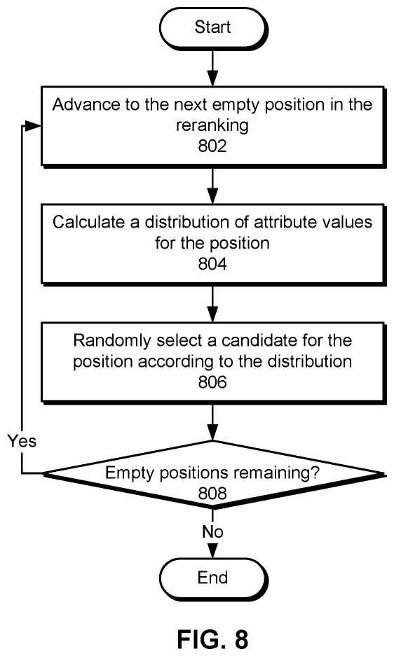

A reranking of recommended candidates is then generated based on the attribute-specific rankings and one or more ranking criteria associated with the target proportions (operation 608), as described in further detail below with respect to FIGS. 7-8. Finally, at least a portion of the reranking is outputted in a response to the request (operation 610).

FIG. 7 shows a flowchart illustrating a process of generating a reranking of recommended candidates based on target proportions of multiple attribute values in accordance with the disclosed embodiments. In one or more embodiments, one or more of the steps may be omitted, repeated, and/or performed in a different order. Accordingly, the specific arrangement of steps shown in FIG. 7 should not be construed as limiting the scope of the embodiments.

Initially, for each position in the reranking and each attribute value, a minimum number of candidates required to maintain a target proportion of the attribute value from the top of the reranking to the position is calculated (operation 702). As mentioned above, the minimum number of candidates may be calculated from the number of candidates from the top of the reranking to the position, the target proportion of the attribute value, and/or a tolerance factor.

Next, the reranking is performed by advancing to the next empty position in the ranking (operation 704), starting at the top of the ranking. A candidate is then selected for the position based on whether or not the minimum numbers calculated in operation 702 are met (operation 706). If the minimum number of candidates is not met for one or more attribute values, a candidate with the highest score from a subset of attribute-specific rankings with the unmet minimum number is moved to the position (operation 708).

If the minimum number of candidates is met for all attribute values at the position, another candidate from the attribute-specific rankings is moved to the position based on one or more ranking criteria (operation 710).

For example, a maximum number of candidates may optionally be calculated for each position in the ranking and each attribute value. Like the minimum number, the maximum number may be calculated from the number of candidates from the top of the reranking to the position, the target proportion of the attribute value, and/or a tolerance factor. If a maximum number of candidates with an attribute value will be exceeded by including the attribute value in the position, the attribute value may be removed from consideration for the position.

In another example, a greedy reranking technique may move the highest-scoring candidate from all attribute-specific rankings to the position. In a third example, a look-ahead reranking technique may identify an attribute value in the reranking with a lowest number of fractional number of candidates between the position and a subsequent position at which the minimum number of candidates for the attribute value increases and move the candidate from an attribute-specific ranking with the attribute value to the position. In a fourth example, a relaxed variation of the look-ahead reranking technique may identify one or more attribute values with a lowest number of integer candidates between the position and a subsequent position at which the minimum number of candidates for the attribute value(s) increases and move a candidate with the highest score from one or more attribute-specific rankings with the attribute value(s) to the position.

Operations 704-710 may be repeated while empty positions remain (operation 712) in the reranking. Each position may be filled with a candidate based on minimum numbers of candidates required to maintain target proportions at the position and/or other ranking criteria.

FIG. 8 shows a flowchart illustrating a process of generating a reranking of recommended candidates based on target proportions of multiple attribute values in accordance with the disclosed embodiments. In one or more embodiments, one or more of the steps may be omitted, repeated, and/or performed in a different order. Accordingly, the specific arrangement of steps shown in FIG. 8 should not be construed as limiting the scope of the embodiments.

The reranking is performed by advancing to the next empty position in the reranking (operation 802), starting at the top of the ranking. Next, a distribution of attribute values is calculated for the position (operation 804). For example, if the position is the first position in the ranking, the distribution may be calculated by multiplying the target proportion of each attribute value by the score of the highest-ranked candidate in the attribute-specific ranking for the attribute value and including the product in the distribution. If the position is after the first position in the reranking, the distribution may be calculated by scaling the target proportion of the attribute value by a ratio of the current proportion of the attribute value in the reranking to the target proportion of the attribute value, multiplying the scaled target proportion by a score for the highest-ranked candidate in the attribute-specific ranking with the attribute value to obtain a probability of selecting the attribute value for the position, and including the probability in the distribution. The ratio may optionally be modified using a hyperparameter to control the effect of the current proportion on the probability.

A candidate for the position is then randomly selected according to the distribution (operation 806). For example, the candidate may be selected by sampling from the distribution, so that an attribute value with a higher probability in the distribution is more likely to be selected than an attribute value with a lower probability.

Operations 802-806 may be repeated while empty positions remain (operation 808) in the reranking. Each position may be filled with a candidate that is randomly selected according to a distribution that accounts for the target proportions of the attribute values, scores of the current highest-ranked candidates in the attribute-specific rankings, and/or current proportions of the attribute values in the reranking. In turn, the reranking may be generated in a nondeterministic fashion that attempts to balance the relevance or quality of the reranking with fairness to the representation of the attribute values.

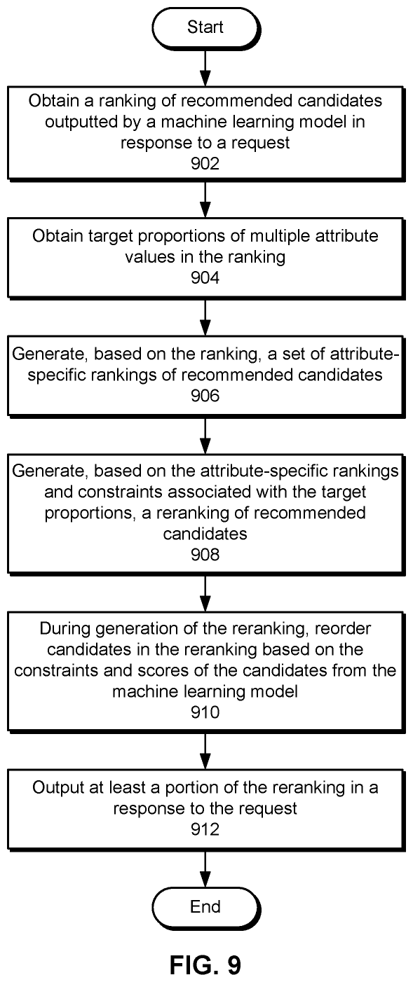

FIG. 9 shows a flowchart illustrating a process of performing interval constrained sorting for feasible bias mitigation in accordance with the disclosed embodiments. In one or more embodiments, one or more of the steps may be omitted, repeated, and/or performed in a different order. Accordingly, the specific arrangement of steps shown in FIG. 9 should not be construed as limiting the scope of the embodiments.

Initially, a ranking of recommended candidates outputted by a machine learning model in response to a request (operation 902) and target proportions of multiple attribute values in the ranking are obtained (operation 904), as described above. Next, a set of attribute-specific rankings of recommended candidates is generated based on the ranking (operation 906).

A reranking of recommended candidates that meets the target proportions is then generated based on the attribute-specific rankings and constraints associated with the target proportions (operation 908). During generation of the reranking, candidates in the reranking are reordered based on the constraints and scores of the candidates from the machine learning model (operation 910).

For example, a minimum number of candidates required to maintain a target proportion of an attribute value from the top of the reranking to a given position in the reranking is calculated for each position in the reranking and each attribute value. A certain number of positions is then skipped until the minimum number of candidates for one or more attribute values has increased at a given position. At that point, one or more candidates with the highest scores for the attribute value(s) are moved to the highest empty positions in the reranking. The score of each candidate and the lowest position in the reranking that can be reached by the candidate without falling below the corresponding minimum number of candidates are also tracked. The position of the candidate may also be swapped with a higher position in the reranking until the higher position includes another candidate with a higher score than the candidate and/or the other candidate is already at the lowest position that can be reached without falling below the minimum number of candidates with the other candidate's attribute value. Consequently, the candidates may be added to the reranking and shuffled between various positions in the reranking according to the constraints associated with the scores and lowest positions until the reranking is complete.

Finally, at least a portion of the reranking is outputted in a response to the request (operation 912). Because the reranking is performed to meet constraints representing feasibility conditions for the target proportions, the target proportions may be met from the top of the reranking to each position in the reranking (as long as the target proportions are found in the set of candidates used to populate the reranking).

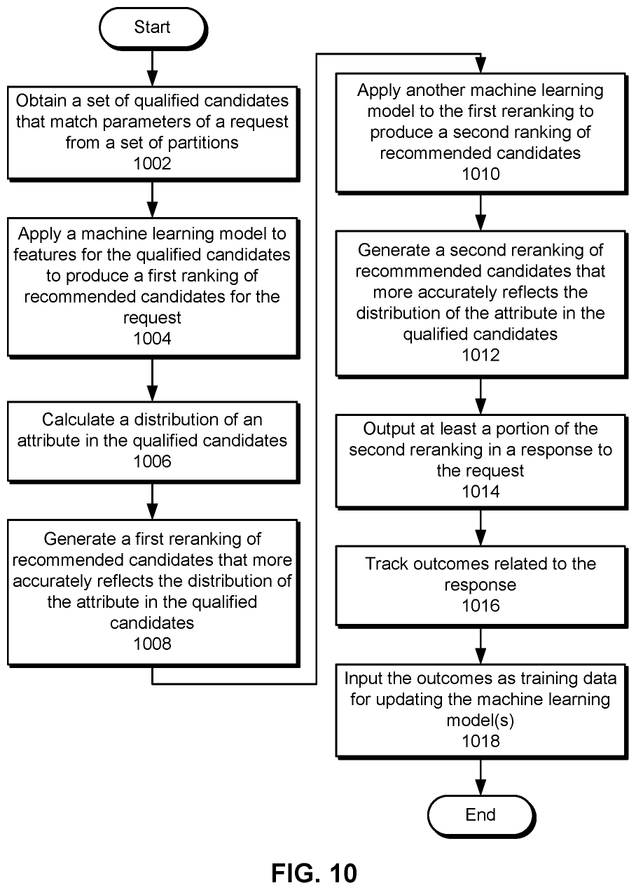

FIG. 10 shows a flowchart illustrating a process of performing multi-level reranking to mitigate machine learning model bias in accordance with the disclosed embodiments. In one or more embodiments, one or more of the steps may be omitted, repeated, and/or performed in a different order. Accordingly, the specific arrangement of steps shown in FIG. 10 should not be construed as limiting the scope of the embodiments.

First, a set of qualified candidates that match parameters of a request is obtained from a set of partitions (operation 1002). For example, each partition may receive the request and determine a static ranking of candidates that match the parameters of the request. The static ranking may be generated based on attributes such as profile quality, profile completeness, influencer status, and/or a number of followers. The partition may then return a pre-specified number of top-ranked candidates from the static ranking as a subset of the qualified candidates that match the parameters of the request.

Next, a machine learning model is applied to features for the qualified candidates to produce a first ranking of recommended candidates for the request (operation 1004). For example, the machine learning model may output scores for the candidates based on the features and/or additional features associated with the parameters, and the candidates may be ranked by descending score.

A distribution of an attribute in the qualified candidates is calculated (operation 1006), and a first reranking of recommended candidates that more accurately reflects the distribution of the attribute in the qualified candidates is generated (operation 1008). For example, the distribution may include proportions of different values of the attribute in the set of qualified candidates. The distribution may be calculated by the partitions in parallel with generating the set of qualified candidates from the parameters. The distribution may further be calculated from candidates returned by the partitions and/or all candidates in each partition that match the parameters of the request. In turn, the first reranking may be produced so that candidates from the top of the reranking to each position in the reranking adhere to the distribution better than candidates from the top of the original ranking to each position in the original ranking.

Another machine learning model is then applied to the first reranking to produce a second ranking of recommended candidates (operation 1010), and a second reranking of recommended candidates that more accurately reflects the distribution of the attribute in the qualified candidates is generated (operation 1012) from the second ranking. For example, the other machine learning model may be applied to a subset of candidates in the first reranking to produce a set of more accurate scores. The second ranking may be generated by ordering the subset of candidates by scores from the other machine learning model, and the second reranking may be performed to reorder the subset of candidates based on the distribution of the attribute in the larger set of qualified candidates. At least a portion of the second reranking is then outputted in a response to the request (operation 1014).

Outcomes related to the response are tracked (operation 1016) and inputted as training data for updating the machine learning model(s) (operation 1018). For example, each outcome may include a request, recruiter, and candidate. The outcome may be used as a positive training example for the machine learning model(s) if subsequent interaction occurs between the recruiter and candidate after the recruiter views the candidate in the response and as a negative training example otherwise. As additional training data is collected and used to update the machine learning models, the accuracy and/or performance of the machine learning models may improve.

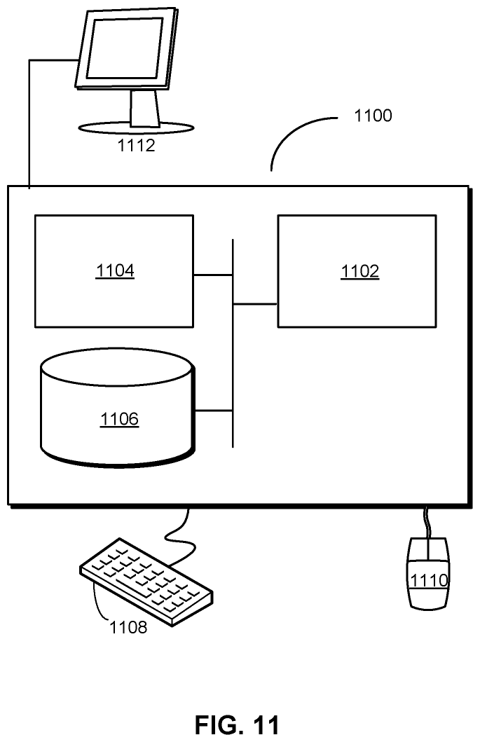

FIG. 11 shows a computer system 1100 in accordance with the disclosed embodiments. Computer system 1100 includes a processor 1102, memory 1104, storage 1106, and/or other components found in electronic computing devices. Processor 1102 may support parallel processing and/or multi-threaded operation with other processors in computer system 1100. Computer system 1100 may also include input/output (I/O) devices such as a keyboard 1108, a mouse 1110, and a display 1112.

Computer system 1100 may include functionality to execute various components of the disclosed embodiments. In particular, computer system 1100 may include an operating system (not shown) that coordinates the use of hardware and software resources on computer system 1100, as well as one or more applications that perform specialized tasks for the user. To perform tasks for the user, applications may obtain the use of hardware resources on computer system 1100 from the operating system, as well as interact with the user through a hardware and/or software framework provided by the operating system.

In one or more embodiments, computer system 1100 provides a system for detecting and mitigating machine learning model bias. The system may include a monitoring system, one or more rankers, a management apparatus, and/or a model training apparatus, one or more of which may alternatively be termed or implemented as a module, mechanism, or other type of system component. To quantify machine learning model bias, the system obtains a set of qualified candidates that match parameters of a request. Next, the system obtains a ranking of recommended candidates outputted by a machine learning model in response to the request. The system then generates a first distribution of an attribute in the ranking of recommended candidates and a second distribution of the attribute in the set of qualified candidates. The system also calculates, based on the first and second distributions, a skew metric representing a difference between a first proportion of an attribute value in the ranking of recommended candidates and a second proportion of the attribute value in the set of qualified candidates. Finally, the system outputs the skew metric for use in evaluating bias in the machine learning model.

To mitigate machine learning model bias, the system obtains a set of qualified candidates that match parameters of a request. Next, the system obtains a ranking of recommended candidates outputted by a machine learning model in response to the request. The system then determines, based on a first distribution of an attribute in the ranking of recommended candidates and a second distribution of the attribute in the set of qualified candidates, an underrepresented group with an attribute value in the ranking of recommended candidates. The system also determines a target proportion of the attribute value that improves a fairness to the underrepresented group in the ranking of recommended candidates. Finally, the system generates, from the ranking of recommended candidates, a reranking of recommended candidates that includes the target proportion of the attribute value.

The system may also, or instead, obtain target proportions of multiple attribute values in the ranking of recommended candidates. The system then generates, based on the ranking, a set of attribute-specific rankings of recommended candidates. The system also generates, based on the set of attribute-specific rankings and one or more ranking criteria associated with the target proportions, a reranking of recommended candidates. Finally, the system outputs at least a portion of the reranking in a response to the request.

The system may also, or instead, use the set of attribute-specific rankings and constraints associated with the target proportions to generate a reranking of recommended candidates that meets the target proportions. During generation of the reranking, the system reorders candidates in the reranking based on the constraints and scores of the candidates from the machine learning model. Finally, the system outputs at least a portion of the reranking in a response to the request.

The system may also, or instead, apply a machine learning model to features for a set of qualified candidates that match parameters of a request to produce a first ranking of recommended candidates. Next, the system calculates a distribution of an attribute in the set of qualified candidates and generates a first reranking of recommended candidates that better reflects the distribution of the attribute in the qualified candidates. The system then applies another machine learning model to the first reranking to produce a second ranking of recommended candidates and generates a second reranking of recommended candidates that better reflects the distribution of the attribute in the qualified candidates. Finally, the system outputs at least a portion of the second reranking in a response to the request.

In addition, one or more components of computer system 1100 may be remotely located and connected to the other components over a network. Portions of the present embodiments (e.g., application, monitoring system, data repository, rankers, model-training apparatus, management apparatus, feature repository, model repository, etc.) may also be located on different nodes of a distributed system that implements the embodiments. For example, the present embodiments may be implemented using a cloud computing system that detects, quantifies, and/or mitigates bias in rankings outputted by a set of remote machine learning models.

By configuring privacy controls or settings as they desire, members of a social network, a professional network, or other user community that may use or interact with embodiments described herein can control or restrict the information that is collected from them, the information that is provided to them, their interactions with such information and with other members, and/or how such information is used. Implementation of these embodiments is not intended to supersede or interfere with the members' privacy settings.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor (including a dedicated or shared processor core) that executes a particular software module or a piece of code at a particular time, and/or other programmable-logic devices now known or later developed. When the hardware modules or apparatus are activated, they perform the methods and processes included within them.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
applying, by a first ranker executing on one or more processors, a machine learning model to features for a set of qualified candidates that match parameters of a request to produce a first ranking of recommended candidates for the request;
calculating, by the first ranker, a distribution of an attribute in the set of qualified candidates;
generating, by the first ranker, a first reranking of recommended candidates that more accurately reflects the distribution of the attribute in the set of qualified candidates; and
generating a result of the request from at least a portion of the first reranking.

2. The method of claim 1, wherein generating the result of the request from at least the portion of the reranking comprises:
applying, by a second ranker, another machine learning model to the first reranking to produce a second ranking of recommended candidates;
generating a second reranking of recommended candidates that more accurately reflects the distribution of the attribute in the set of qualified candidates; and
outputting at least a portion of the second reranking in a response to the request.

3. The method of claim 2, further comprising:
tracking outcomes related to the response; and
inputting the outcomes as training data for updating the first or second machine learning models.

4. The method of claim 3, wherein the outcomes comprise at least one of:
the request;
a recruiter; and
a candidate.

5. The method of claim 2, wherein the first and second rerankings are generated using at least one of:
a minimum number of candidates required to maintain a target proportion of an attribute value;
a number of candidates between a position in the reranking and a subsequent position at which the minimum number of candidates will be reached;
a tolerance factor associated with the target proportion;
random selection of a candidate for the position based on a distribution calculated from the target proportion, a score of the candidate, and a current proportion of the attribute value in the reranking up to the position; and
reordering candidates in the reranking based on constraints associated with the target proportion and the score.

6. The method of claim 1, further comprising:
obtaining the set of qualified candidates from a set of partitions.

7. The method of claim 6, wherein obtaining the set of qualified candidates from the set of partitions comprises:
determining, at each partition in the set of partitions, a static ranking of candidates that match the parameters of the request; and
returning a pre-specified number of top-ranked candidates from the static ranking as a subset of the qualified candidates.

8. The method of claim 7, wherein calculating the distribution of the attribute in the set of qualified candidates comprises at least one of:
calculating the distribution of the attribute from the pre-specified number of candidates that match the parameters of the request; and
calculating the distribution of the attribute from all candidates in the partition that match the parameters of the request.

9. The method of claim 7, wherein the static ranking is determined using at least one of:
a profile quality;
a profile completeness;
an influencer status; and
a number of followers.

10. The method of claim 1, wherein generating the first reranking of recommended candidates comprises:
applying another machine learning model to the first reranking to produce a second ranking of recommended candidates; and
generating, based on the distribution of the attribute in the set of qualified candidates and the second ranking, the reranking of the recommended candidates that more accurately reflects the distribution of the attribute in the set of qualified candidates.

11. The method of claim 1, wherein the first ranker calculates the distribution of the attribute in parallel with producing the first ranking of recommended candidates.

12. The method of claim 1, wherein the parameters comprise at least one of:
a location;
an industry;
a title;
a skill;
a school;
a degree;
a company;
a work experience; and
a seniority.

13. The method of claim 1, wherein the attribute is at least one of:
a gender;
an age range;
an ethnicity; and
a combination of two or more attributes.

14. A system, comprising:
one or more processors; and
memory storing instructions that, when executed by the one or more processors, cause the apparatus to:
apply a machine learning model to features for a set of qualified candidates that match parameters of a request to produce a first ranking of recommended candidates for the request;
calculate a distribution of an attribute in the set of qualified candidates;
generate a first reranking of recommended candidates that more accurately reflects the distribution of the attribute in the set of qualified candidates; and
generate a result of the request from at least a portion of the first reranking.

15. The system of claim 14, wherein generating the result of the request from at least the portion of the reranking comprises:
applying another machine learning model to the first reranking to produce a second ranking of recommended candidates;
generating a second reranking of recommended candidates that more accurately reflects the distribution of the attribute in the set of qualified candidates; and
outputting at least a portion of the second reranking in a response to the request.

16. The system of claim 14, wherein obtaining the set of qualified candidates from the set of partitions comprises:
determining, at each partition in the set of partitions, a static ranking of candidates that match the parameters of the request; and
returning a pre-specified number of top-ranked candidates from the static ranking as a subset of the qualified candidates.

17. The system of claim 16, wherein the static ranking is determined using at least one of:
a profile quality;
a profile completeness;
an influencer status; and
a number of followers.

18. The system of claim 14, wherein generating the first reranking of recommended candidates comprises:
applying another machine learning model to the first reranking to produce a second ranking of recommended candidates; and
generating, based on the distribution of the attribute in the set of qualified candidates and the second ranking, the reranking of the recommended candidates that more accurately reflects the distribution of the attribute in the set of qualified candidates.

19. The system of claim 14, wherein the distribution of the attribute is calculated in parallel with producing the first ranking of recommended candidates.

20. A non-transitory computer-readable storage medium storing instructions that when executed by a computer cause the computer to perform a method, the method comprising:
applying a machine learning model to features for a set of qualified candidates that match parameters of a request to produce a first ranking of recommended candidates for the request;
calculating a distribution of an attribute in the set of qualified candidates;
generating a first reranking of recommended candidates that more accurately reflects the distribution of the attribute in the set of qualified candidates;
applying another machine learning model to the first reranking to produce a second ranking of recommended candidates;
generating a second reranking of recommended candidates that more accurately reflects the distribution of the attribute in the set of qualified candidates; and
outputting at least a portion of the second reranking in a response to the request.
